(19) United States
(12) Patent Application Publication
(10) Pub. No.: US 2022/0165138 A1
(43) Pub. Date: May 26, 2022

(54) GUIDANCE SYSTEM AND GUIDANCE METHOD

(71) Applicant: Mitsubishi Electric Corporation, Tokyo (JP)

(72) Inventors: Tatsunari KATAOKA, Tokyo (JP); Reiko SAKATA, Tokyo (JP)

(73) Assignee: Mitsubishi Electric Corporation, Tokyo (JP)

(21) Appl. No.: 17/667,566

(22) Filed: Feb. 9, 2022

Related U.S. Application Data
(63) Continuation of application No. PCT/JP2019/042389, filed on Oct. 29, 2019.

(51) Int. Cl. G08B 7/06; G06T 13/80; H04N 9/31; G01C 21/20

(52) U.S. Cl. CPC G08B 7/066; G06T 13/80; B64F 1/366; G01C 21/206; H04N 9/3147

(57) ABSTRACT

A guidance system includes a projection device group that projects a guidance image group onto a projection target area in a guidance target space, the projection target area includes a plurality of partial areas, the projection device group includes a plurality of projection devices corresponding to the plurality of partial areas, the guidance image group includes two or more animated guidance images, and each of two or more of the plurality of projection devices projects each of two or more animated guidance images so as to form a visual content for guidance that is continuous by cooperation of the two or more animated guidance images.

### CROSS-REFERENCE TO RELATED APPLICATION

The present application is a continuation of International Patent Application PCT/JP2019/042389, filed Oct. 29, 2019, the entire contents of which are incorporated herein by reference.

### TECHNICAL FIELD

The present invention relates to a guidance system and a guidance method.

### BACKGROUND ART

Conventionally, a system of guiding a person to be guided (hereinafter referred to as “guidance target person”) using an image projected on a floor surface portion in a space to be guided (hereinafter, referred to as “guidance target space”) has been developed (see, for example, Patent Literature 1).

### CITATION LIST

### Patent Literatures

Patent Literature 1: JP 2011-134172 A

### SUMMARY OF INVENTION

### Technical Problem

When the guidance target space is a large space (for example, an airport departure lounge), in some cases, guidance over a long distance is required. At this time, guidance with a plurality of routes may be required. For such guidance, two or more images are used. Here, the distance at which (that is, the area in which) an image can be projected by each projector is limited. Consequently, two or more images related to the guidance are each projected by two or more projectors.

When two or more images related to a series of guidance are projected by two or more projectors, in some cases, the guidance target person erroneously recognizes that the two or more images do not relate to the series of guidance. For example, if a part of the two or more images and the remaining of the two or more images are projected so as to be temporally or spatially separated (that is, discontinuously), the part of the images may be recognized as related to the series of guidance, but the remaining may be erroneously recognized as not related to the series of guidance. Due to the occurrence of such erroneous recognition, there is a disadvantage that the guidance target person cannot be accurately guided.

The present invention has been made to solve the above disadvantage, and an object thereof is to cause a guidance target person to visually recognize that, when two or more images related to a series of guidance are projected, the two or more images are related to the series of guidance.

### Solution to Problem

A guidance system of the present invention includes a projection device group to project a guidance image group onto a projection target area in a guidance target space, wherein the projection target area includes a plurality of partial areas including a plurality of guidance routes and arranged depending on a shape of the plurality of guidance routes, the projection device group includes a plurality of projection devices corresponding to the plurality of partial areas, the guidance image group includes two or more animated guidance images in each of the plurality of guidance routes, and each of two or more of the plurality of projection devices sequentially projects, in each of the plurality of guidance routes, each of the two or more animated guidance images corresponding to each of the plurality of guidance routes so as to form a visual content for guidance that is continuous by cooperation of the two or more animated guidance images.

### Advantageous Effects of Invention

According to the present invention, with the above configuration, it is possible to cause a guidance target person to visually recognize for each of a plurality of guidance routes, that, when two or more images related to a series of guidance are projected, the two or more images are related to the series of guidance.

Furthermore, it is possible to appropriately perform guidance in each guidance route depending on the length of each of the plurality of guidance routes.

### BRIEF DESCRIPTION OF DRAWINGS

FIG. 1 is a block diagram illustrating a system configuration of a guidance system according to a first embodiment.

FIG. 2A is a block diagram illustrating a hardware configuration of a control device in the guidance system according to the first embodiment.

FIG. 2B is a block diagram illustrating another hardware configuration of the control device in the guidance system according to the first embodiment.

FIG. 3A is a block diagram illustrating a hardware configuration of each projection device in the guidance system according to the first embodiment.

FIG. 3B is a block diagram illustrating another hardware configuration of each projection device in the guidance system according to the first embodiment.

FIG. 4 is a block diagram illustrating a functional configuration of the guidance system according to the first embodiment.

FIG. 5 is a flowchart illustrating an operation of the guidance system according to the first embodiment.

FIG. 6 is an explanatory diagram illustrating an example of a guidance target space.

FIG. 7A is an explanatory diagram illustrating an example of a state where a plurality of guidance images are projected in the guidance target space illustrated in FIG. 6.

FIG. 7B is an explanatory diagram illustrating an example of the state where a plurality of guidance images are projected in the guidance target space illustrated in FIG. 6.

FIG. 7C is an explanatory diagram illustrating an example of the state where a plurality of guidance images are projected in the guidance target space illustrated in FIG. 6.

FIG. 8 is an explanatory diagram illustrating another example of the guidance target space.

FIG. 9A is an explanatory diagram illustrating an example of a state where a plurality of guidance images are projected in the guidance target space illustrated in FIG. 8.

FIG. 9B is an explanatory diagram illustrating an example of the state where a plurality of guidance images are projected in the guidance target space illustrated in FIG. 8.

FIG. 9C is an explanatory diagram illustrating an example of the state where a plurality of guidance images are projected in the guidance target space illustrated in FIG. 8.

FIG. 9D is an explanatory diagram illustrating an example of the state where a plurality of guidance images are projected in the guidance target space illustrated in FIG. 8.

FIG. 9E is an explanatory diagram illustrating an example of the state where a plurality of guidance images are projected in the guidance target space illustrated in FIG. 8.

FIG. 9F is an explanatory diagram illustrating an example of the state where a plurality of guidance images are projected in the guidance target space illustrated in FIG. 8.

FIG. 9G is an explanatory diagram illustrating an example of the state where a plurality of guidance images are projected in the guidance target space illustrated in FIG. 8.

FIG. 10 is a block diagram illustrating another functional configuration of the guidance system according to the first embodiment.

FIG. 11 is a block diagram illustrating a system configuration of a guidance system according to a second embodiment.

FIG. 12 is a block diagram illustrating a functional configuration of the guidance system according to the second embodiment.

FIG. 13 is a flowchart illustrating an operation of the guidance system according to the second embodiment.

FIG. 14 is an explanatory diagram illustrating another example of the guidance target space.

FIG. 15 is an explanatory diagram illustrating an example of a state where a plurality of guidance images are projected when external information is not acquired in the guidance target space illustrated in FIG. 14.

FIG. 16 is an explanatory diagram illustrating an example of a state where a plurality of guidance images are projected when the external information is acquired in the guidance target space illustrated in FIG. 14.

FIG. 17 is an explanatory diagram illustrating an example of a state where zero guidance images are projected when the external information is not acquired in the guidance target space illustrated in FIG. 14.

FIG. 18 is an explanatory diagram illustrating an example of the state where a plurality of guidance images are projected when the external information is acquired in the guidance target space illustrated in FIG. 14.

FIG. 19 is an explanatory diagram illustrating yet another example of the guidance target space.

FIG. 20A is an explanatory diagram illustrating an example of a state where a plurality of guidance images are projected when external information is acquired in the guidance target space illustrated in FIG. 19.

FIG. 20B is an explanatory diagram illustrating an example of the state where a plurality of guidance images are projected when the external information is acquired in the guidance target space illustrated in FIG. 19.

FIG. 21 is an explanatory diagram illustrating still another example of the guidance target space.

FIG. 22 is an explanatory diagram illustrating an example of a state where a plurality of guidance images are projected when external information is acquired in the guidance target space illustrated in FIG. 21.

FIG. 23 is an explanatory diagram illustrating an example of the state where a plurality of guidance images are projected when the external information is acquired in the guidance target space illustrated in FIG. 21.

FIG. 24 is an explanatory diagram illustrating an example of the state where a plurality of guidance images are projected when the external information is acquired in the guidance target space illustrated in FIG. 21.

FIG. 25 is an explanatory diagram illustrating further example of the guidance target space.

FIG. 26A is an explanatory diagram illustrating an example of a state where a plurality of guidance images are projected when external information is acquired in the guidance target space illustrated in FIG. 25.

FIG. 26B is an explanatory diagram illustrating an example of the state where a plurality of guidance images are projected when the external information is acquired in the guidance target space illustrated in FIG. 25.

FIG. 26C is an explanatory diagram illustrating an example of the state where a plurality of guidance images are projected when the external information is acquired in the guidance target space illustrated in FIG. 25.

FIG. 27 is a block diagram illustrating another functional configuration of the guidance system according to the second embodiment.

### DESCRIPTION OF EMBODIMENTS

Hereinafter, in order to describe the present invention in more detail, modes for carrying out the present invention will be described with reference to the accompanying drawings.

### First Embodiment

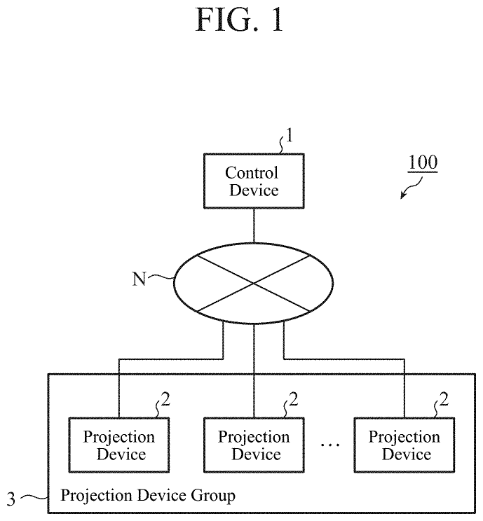

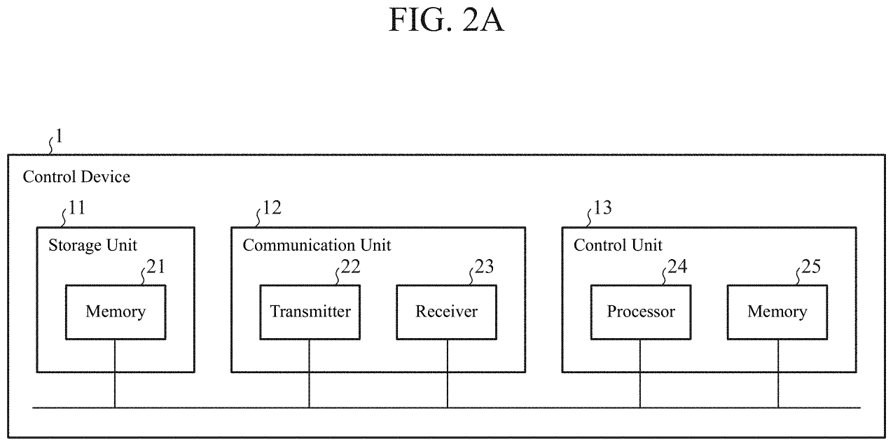

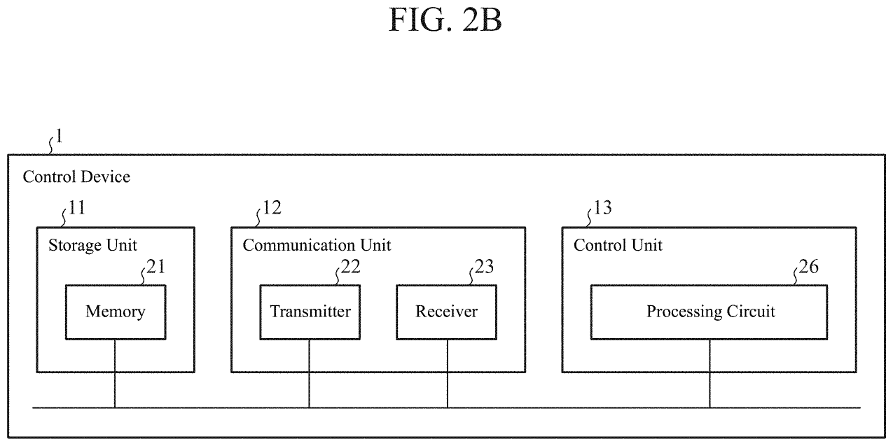

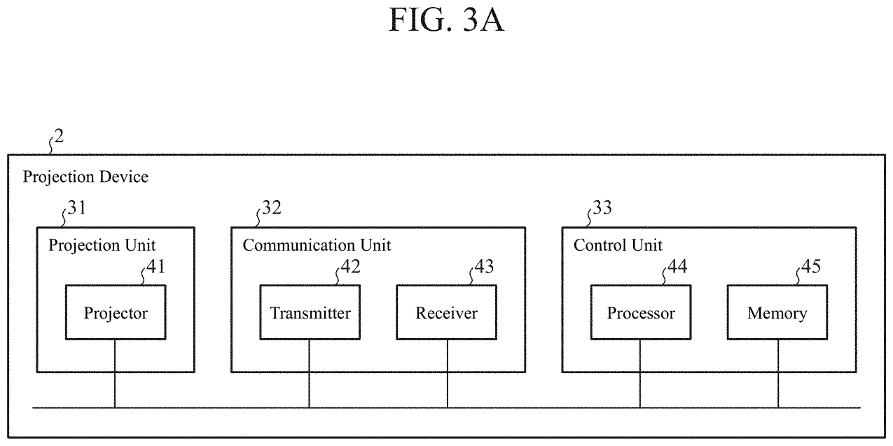

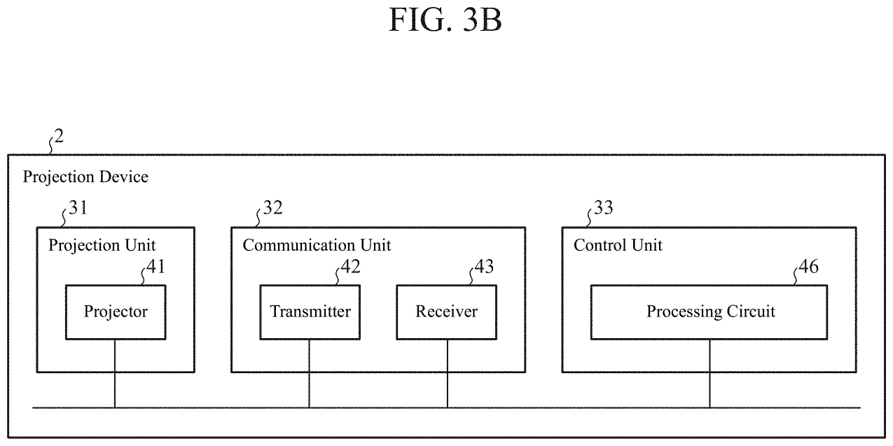

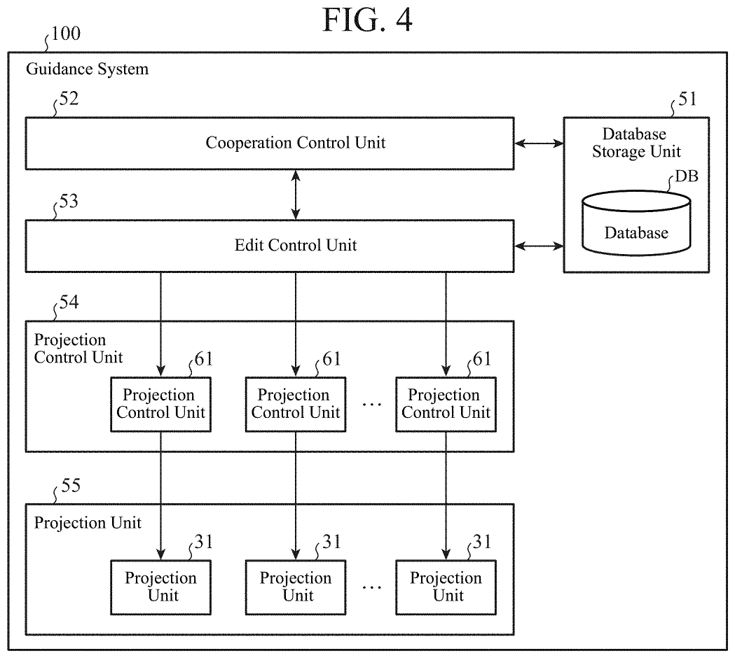

FIG. 1 is a block diagram illustrating a system configuration of a guidance system according to a first embodiment. FIG. 2A is a block diagram illustrating a hardware configuration of a control device in the guidance system according to the first embodiment. FIG. 2B is a block diagram illustrating another hardware configuration of the control device in the guidance system according to the first embodiment. FIG. 3A is a block diagram illustrating a hardware configuration of each projection device in the guidance system according to the first embodiment. FIG. 3B is a block diagram illustrating another hardware configuration of each projection device in the guidance system according to the first embodiment. FIG. 4 is a block diagram illustrating a functional configuration of the guidance system according to the first embodiment. The guidance system according to the first embodiment will be described with reference to FIGS. 1 to 4.

As illustrated in FIG. 1, a guidance system 100 includes a control device 1. The guidance system 100 also includes a plurality of projection devices 2. The plurality of projection devices 2 constitute a projection device group 3. The control device 1 is communicable with each projection device 2 by a computer network N. In other words, each projection device 2 is communicable with the control device 1 by the computer network N.

Each projection device 2 is installed in a guidance target space S. The guidance target space S includes an area (hereinafter referred to as “projection target area”) A where a group of guidance images (hereinafter, referred to as “guidance image group”) IG is projected by the projection device group 3. The guidance image group IG includes a plurality of guidance images (hereinafter, referred to as “guidance images”) I. The projection target area A includes a plurality of areas (hereinafter, referred to as “partial areas”) PA. Each partial area PA is set, for example, on a floor surface portion F or a wall surface portion W in the guidance target space S.

The plurality of partial areas PA correspond to the projection devices 2 on a one-to-one basis. As will be described later with reference to FIG. 4, one or more guidance images I of the plurality of guidance images I are allocated to each of the projection devices 2. Each of the plurality of projection devices 2 projects one or more allocated guidance images I of the plurality of guidance images I onto the corresponding one of the plurality of partial areas PA.

Here, the guidance target space S includes one or more routes for guidance (hereinafter, referred to as “guidance routes”) GR. The plurality of guidance images I include two or more animated images for guidance (hereinafter, referred to as “animated guidance images”) I_A corresponding to each guidance route GR. As each of two or more projection devices 2 of the plurality of projection devices 2 project each of two or more animated guidance images I_A, a continuous visual content VC for guidance corresponding to each guidance route GR is formed. That is, two or more animated guidance images I_A cooperate with each other, so that the visual content VC corresponding to each guidance route GR is formed.

The visual content VC is visually recognized, for example, as if a predetermined number of images with a predetermined shape and a predetermined size (hereinafter, referred to as “unit images”) are moving along each guidance route GR. The unit image includes, for example, one linear or substantially linear image (hereinafter, referred to as “linear image”) or a plurality of linear images. A specific example of the visual content VC will be described later with reference to FIGS. 6 to 9.

As illustrated in FIG. 2, the control device 1 includes a storage unit 11, a communication unit 12, and a control unit 13. The storage unit 11 includes a memory 21. The communication unit 12 includes a transmitter 22 and a receiver 23. The control unit 13 includes a processor 24 and a memory 25. Alternatively, the control unit 13 includes a processing circuit 26.

The memory 21 includes one or a plurality of nonvolatile memories. The processor 24 includes one or a plurality of processors. The memory 25 includes one or a plurality of nonvolatile memories, or one or a plurality of nonvolatile memories and one or a plurality of volatile memories. The processing circuit 26 includes one or a plurality of digital circuits, or one or a plurality of digital circuits and one or a plurality of analog circuits. That is, the processing circuit 26 includes one or a plurality of processing circuits.

Here, each processor uses, for example, a central processing unit (CPU), a graphics processing unit (GPU), a microprocessor, a microcontroller, or a digital signal processor (DSP). Each volatile memory uses, for example, a random access memory (RAM). Each nonvolatile memory uses, for example, a read only memory (ROM), a flash memory, an erasable programmable read only memory (EPROM), an electrically erasable programmable read only memory (EEPROM), a solid state drive, or a hard disk drive. Each processing circuit uses, for example, an application specific integrated circuit (ASIC), a programmable logic device (PLD), a field programmable gate array (FPGA), a system on a chip (SoC), or a system large scale integration (LSI).

As illustrated in FIG. 3, each projection device 2 includes a projection unit 31, a communication unit 32, and a control unit 33. The projection unit 31 includes a projector 41. The communication unit 32 includes a transmitter 42 and a receiver 43. The control unit 33 includes a processor 44 and a memory 45. Alternatively, the control unit 33 includes a processing circuit 46.

The processor 44 includes one or a plurality of processors. The memory 45 includes one or a plurality of nonvolatile memories, or one or a plurality of nonvolatile memories and one or a plurality of volatile memories. The processing circuit 46 includes one or a plurality of digital circuits, or one or a plurality of digital circuits and one or a plurality of analog circuits. That is, the processing circuit 46 includes one or a plurality of processing circuits.

Here, each processor uses, for example, a CPU, a GPU, a microprocessor, a microcontroller, or a DSP. Each volatile memory uses, for example, a RAM. Each nonvolatile memory uses, for example, a ROM, a flash memory, an EPROM, an EEPROM, a solid state drive, or a hard disk drive. Each processing circuit uses, for example, an ASIC, a PLD, an FPGA, an SoC, or a system LSI.

The communication unit 12 of the control device 1 is communicable with the communication unit 32 of each projection device 2 using the computer network N. Such communication allows the control unit 13 of the control device 1 to freely cooperate with the control unit 33 of each projection device 2. In other words, the communication unit 32 of each projection device 2 is communicable with the communication unit 12 of the control device 1 using the computer network N. Such communication allows the control unit 33 of each projection device 2 to freely cooperate with the control unit 13 of the control device 1.

As illustrated in FIG. 4, the guidance system 100 includes a database storage unit 51, a cooperation control unit 52, an edit control unit 53, a projection control unit 54, and a projection unit 55. Here, the projection control unit 54 includes a plurality of projection control units 61. The plurality of projection control units 61 correspond to the plurality of projection devices 2 on a one-to-one basis. The projection unit 55 includes a plurality of projection units 31. The plurality of projection units 31 correspond to the plurality of projection devices 2 on a one-to-one basis (see FIG. 3).

The function of the database storage unit 51 is implemented by, for example, the storage unit 11 of the control device 1 (see FIG. 2). In other words, the database storage unit 51 is provided in the control device 1, for example.

The function of the cooperation control unit 52 is implemented by, for example, the control unit 13 of the control device 1 (see FIG. 2). In other words, the cooperation control unit 52 is provided in the control device 1, for example.

The function of each of the plurality of projection control units 61 is implemented by, for example, the control unit 33 of the corresponding one of the plurality of projection devices 2 (see FIG. 3). In other words, each of the plurality of projection control units 61 is provided in the corresponding one of the plurality of projection devices 2. That is, the plurality of projection control units 61 are each provided in the plurality of projection devices 2.

The database storage unit 51 stores a database DB. The database DB includes a plurality of image data to be edited (hereinafter, referred to as “edit image data”) ID′. The plurality of edit image data ID′ indicate a plurality of images to be edited (hereinafter, referred to as “edit images”) I′.

The cooperation control unit 52 selects one or more edit image data ID among a plurality of edit image data ID included in the database DB. The edit control unit 53 generates a plurality of guidance images I by using one or more edit images I′ indicated by the one or more selected edit image data ID′. That is, the edit control unit 53 edits the guidance image group IG.

The cooperation control unit 52 allocates one or more guidance images I of the plurality of generated guidance images Ito each of the plurality of projection devices 2. The edit control unit 53 outputs one or more image data (hereinafter, referred to as “guidance image data”) ID indicating the one or more allocated guidance images Ito each of the plurality of projection devices 2. Furthermore, the cooperation control unit 52 sets a timing (hereinafter referred to as “projection timing”) at which each of the plurality of generated guidance images I should be projected. The edit control unit 53 outputs information (hereinafter referred to as “projection timing information”) indicating the set projection timing to each of the plurality of projection devices 2.

Here, the following information is used for selection of the edit image data ID′ and allocation of the guidance image I by the cooperation control unit 52, and setting of the projection timing and editing of the guidance image group IG by the edit control unit 53. For example, information indicating the installation position and installation direction of each projection device 2 in the guidance target space S is used. Furthermore, for example, information indicating each guidance route GR, information related to a point (hereinafter, referred to as “guidance start point”) SP corresponding to a start point part of each guidance route GR, information related to a point (hereinafter referred to as “guidance target point”) EP corresponding to an end point part of each guidance route GR, information related to a point (hereinafter, referred to as “non-guidance target point”) NP different from these points SP and EP, and the like are used. These pieces of information are stored in advance in the storage unit 11 of the control device 1, for example. Hereinafter, these pieces of information are collectively referred to as “control information”.

Each of the plurality of projection control units 61 acquires one or more guidance image data ID output by the edit control unit 53. Each of the plurality of projection control units 61 executes control to cause the corresponding one of the plurality of projection units 31 to project one or more guidance images I indicated by the acquired one or more guidance image data ID. As a result, each of the plurality of projection units 31 projects one or more corresponding guidance images I of the plurality of guidance images I onto the corresponding one of the plurality of partial areas PA.

At this time, each of the plurality of projection control units 61 acquires the projection timing information output by the edit control unit 53. Each of the plurality of projection control units 61 controls the timing at which each of the one or more corresponding guidance images I is projected by using the acquired projection timing information.

Hereinafter, in some cases, the control executed by the cooperation control unit 52 is collectively referred to as “cooperation control”. That is, the cooperation control includes control to select the edit image data ID′, control to allocate the guidance image I, control to set the projection timing, and the like.

Furthermore, in some cases, the control executed by the edit control unit 53 is collectively referred to as “edit control”. That is, the edit control includes control to edit the guidance image group IG and the like.

Further, in some cases, the control executed by the projection control unit 54 is collectively referred to as “projection control”. That is, the projection control includes control to cause the projection unit 31 to project the guidance image I and the like.

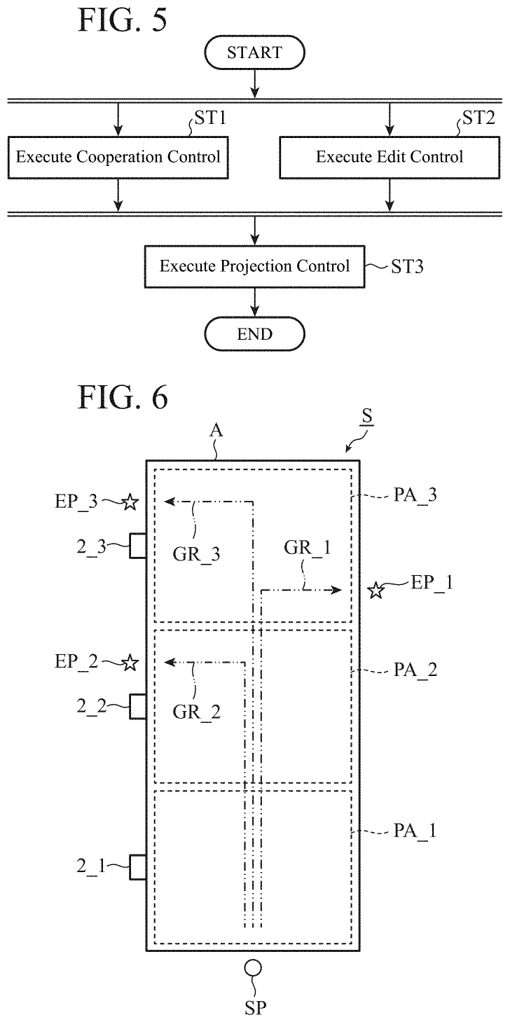

Next, an operation of the guidance system 100 will be described focusing on operations of the cooperation control unit 52, the edit control unit 53, and the projection control unit 54 with reference to the flowchart of FIG. 5.

First, the cooperation control unit 52 executes cooperation control (step ST1), and the edit control unit 53 executes edit control (step ST2). Next, the projection control unit 54 executes projection control (step ST3).

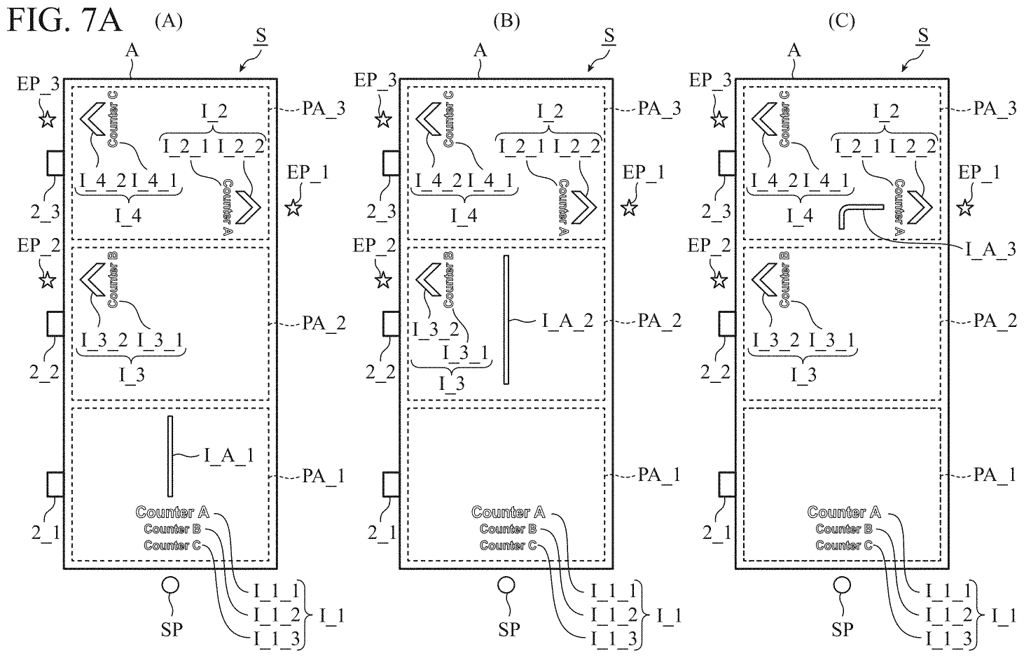

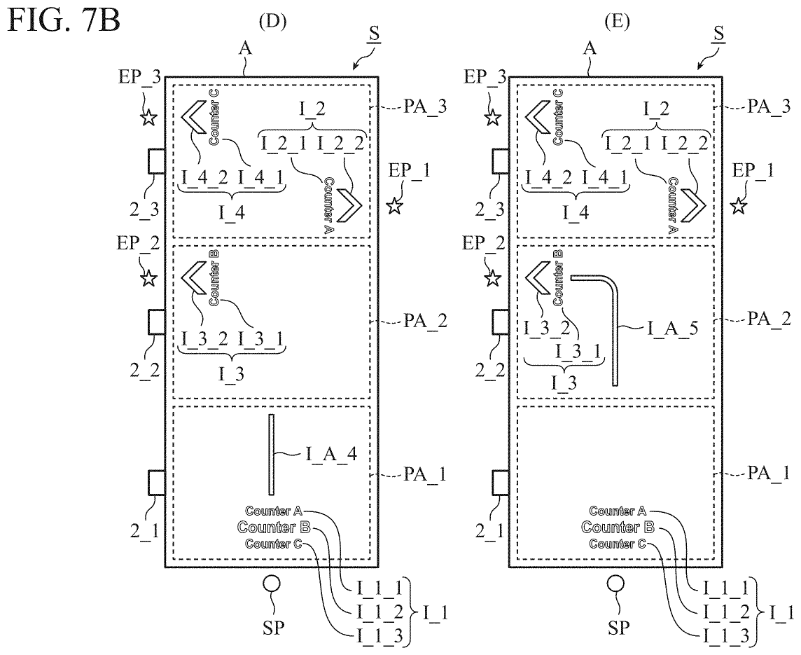

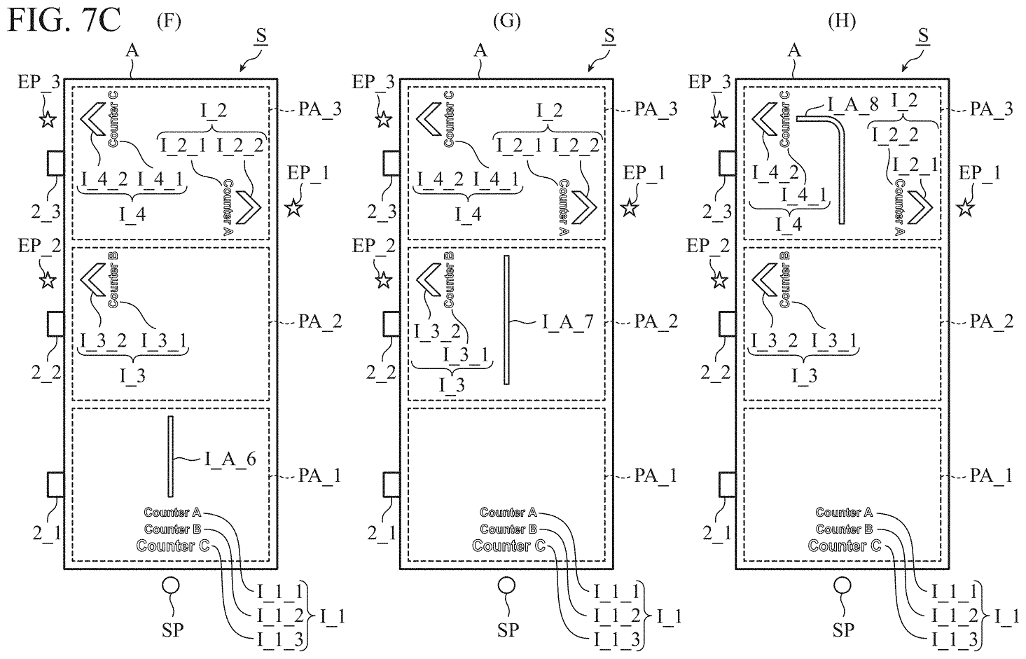

Next, a specific example of the visual content VC implemented by the guidance system 100 will be described with reference to FIGS. 6 and 7.

Now, there are a plurality of check-in counters in an airport departure lounge. The check-in counters include a first check-in counter (“A counter” in the drawing), a second check-in counter (“B counter” in the drawing), and a third check-in counter (“C” counter in the drawing). The guidance target space S in the example illustrated in FIGS. 6 and 7 is a space in the airport departure lounge.

As illustrated in FIG. 6, three guidance routes GR_1, GR_2, and GR_3 are set in the guidance target space S. Each of the guidance routes GR_1, GR_2, and GR_3 corresponds to the guidance start point SP. The guidance routes GR_1, GR_2, and GR_3 correspond to the guidance target points EP_1, EP_2, and EP_3, respectively. The guidance target point EP_1 corresponds to the first check-in counter. The guidance target point EP_2 corresponds to the second check-in counter. The guidance target point EP_3 corresponds to the third check-in counter.

In the example illustrated in FIGS. 6 and 7, the projection target area A includes three partial areas PA_1, PA_2, and PA_3. In the guidance target space S, three projection devices 2_1, 2_2, and 2_3 corresponding to the three partial areas PA_1, PA_2, and PA_3 on a one-to-one basis are installed.

The individual partial areas PA_1, PA_2, and PA_3 are set on the floor surface portion F. The three partial areas PA_1, PA_2, and PA_3 are arranged along the guidance route GR_1 and the guidance route GR_3. Further, two partial areas PA_1 and PA_2 of the three partial areas PA_1, PA_2, and PA_3 are arranged along the guidance route GR_2.

First, the projection control unit 54 executes projection control in such a manner that the state illustrated in FIG. 7A continues for a predetermined time T. Next, the projection control unit 54 executes the projection control in such a manner that the state illustrated in FIG. 7B continues for the predetermined time T. Next, the projection control unit 54 executes the projection control in such a manner that the state illustrated in FIG. 7C continues for the predetermined time T. Thereafter, the projection control unit 54 repeatedly executes such projection control. That is, such projection control is executed at a predetermined period Δ. The value of T is set to a value based on projection timing information. For example, the value of T is set to a value of about five seconds. As a result, the cycle Δ is a cycle of about ten to twenty seconds.

The state illustrated in FIG. 7A is a state corresponding to guidance with the guidance route GR_1. The state illustrated in FIG. 7B is a state corresponding to guidance by the guidance route GR_2. The state illustrated in FIG. 7C is a state corresponding to the guidance with the guidance route GR_3.

As illustrated in each of FIGS. 7A, 7B, and 7C, a guidance image I_1 is projected at a position corresponding to the guidance start point SP in the partial area PA_1. The guidance image I_1 includes text images I_1_1, I_1_2, and I_1_3. The text image I_1_1 includes a Japanese character string that means “counter A”. The text image I_1_2 includes a Japanese character string that means “counter B”. The text image I_1_3 includes a Japanese character string that means “counter C”.

In the state illustrated in FIG. 7A, the image I_1_1 is projected larger than each of the images I_1_2 and I_1_3. In the state illustrated in FIG. 7B, the image I_1_2 is projected larger than each of the images I_1_1 and I_1_3. In the state illustrated in FIG. 7C, the image I_1_3 is projected larger than each of the images I_1_1 and I_1_2.

As illustrated in each of FIGS. 7A, 7B, and 7C, a guidance image I_2 is projected at a position corresponding to the guidance target point EP_1 in the partial area PA_3. The guidance image I_2 includes a text image I_2_1 and an arrow image I_2_2. The text image I_2_1 includes the Japanese character string that means “counter A”. The arrow image I_2_2 indicates the position of the first check-in counter.

As illustrated in each of FIGS. 7A, 7B, and 7C, a guidance image I_3 is projected at a position corresponding to the guidance target point EP_2 in the partial area PA_2. The guidance image I_3 includes a text image I_3_1 and an arrow image I_3_2. The text image I_3_1 includes the Japanese character string that means “counter B”. The arrow image I_3_2 indicates the position of the second check-in counter.

As illustrated in each of FIGS. 7A, 7B, and 7C, a guidance image I_4 is projected at a position corresponding to the guidance target point EP_3 in the partial area PA_3. The guidance image I_4 includes a text image I_4_1 and an arrow image I_4_2. The text image I_4_1 includes the Japanese character string that means “counter C”. The arrow image I_4_2 indicates the position of the third check-in counter.

Here, in the state illustrated in FIG. 7A, animated guidance images I_A_1, I_A_2, and I_A_3 are projected by the projection devices 2_1, 2_2, and 2_3, respectively. The animated guidance images I_A_1, I_A_2, and I_A_3 are sequentially projected for a predetermined time t. In addition, the animated guidance images I_A_1, I_A_2, and I_A_3 are repeatedly projected for the predetermined time T. The visual content VC_1 is formed by the cooperation of the animated guidance images I_A_1, I_A_2, and I_A_3. The visual content VC_1 is visually recognized, for example, as if one linear image is moving along the guidance route GR_1. The value of t is set to a value based on the projection timing information. For example, the value of t is set to a value of about one to two seconds.

With such cooperation, guidance with the guidance route GR_1 across the partial areas PA_1, PA_2, and PA_3 can be implemented. That is, guidance over a long distance can be implemented. In addition, it is possible to cause a guidance target person to visually recognize that the animated guidance images I_A_1, I_A_2, and I_A_3 relate to a series of guidance even though a simple unit image (that is, one linear image) is used.

In the state illustrated in FIG. 7B, animated guidance images I_A_4 and I_A_5 are projected by the projection devices 2_1 and 2_2, respectively. The animated guidance images I_A_4 and I_A_5 are sequentially projected for the predetermined time t. The animated guidance images I_A_4 and I_A_5 are repeatedly projected for the predetermined time T. The visual content VC_2 is formed by the cooperation of the animated guidance images I_A_4 and I_A_5. The visual content VC_2 is visually recognized, for example, as if one linear image is moving along the guidance route GR_2.

With such cooperation, guidance with the guidance route GR_2 across the partial areas PA_1 and PA_2 can be implemented. That is, guidance over a long distance can be implemented. In addition, it is possible to cause the guidance target person to visually recognize that the animated guidance images I_A_4 and I_A_5 relate to a series of guidance even though a simple unit image (that is, one linear image) is used.

Furthermore, in the state illustrated in FIG. 7C, animated guidance images I_A_6, I_A_7, and I_A_8 are projected by the projection devices 2_1, 2_2, and 2_3, respectively. The animated guidance images I_A_6, I_A_7, and I_A_8 are sequentially projected for the predetermined time t. In addition, the animated guidance images I_A_6, I_A_7, and I_A_8 are repeatedly projected for the predetermined time T. The visual content VC_3 is formed by the cooperation of the animated guidance images I_A_6, I_A_7, and I_A_8. The visual content VC_3 is visually recognized, for example, as if one linear image is moving along the guidance route GR_3.

With such cooperation, guidance with the guidance route GR_3 across the partial areas PA_1, PA_2, and PA_3 can be implemented. That is, guidance over a long distance can be implemented. In addition, it is possible to cause the guidance target person to visually recognize that the animated guidance images I_A_6, I_A_7, and I_A_8 relate to a series of guidance even though a simple unit image (that is, one linear image) is used.

Here, the arrow image I_2_2 in the state illustrated in FIG. 7A may be an animated arrow image linked with the animated guidance images I_A_1, I_A_2, and I_A_3. That is, one arrow-like visual content VC_1 may be formed as a whole by the animated guidance images I_A_1, I_A_2, and I_A_3 and the arrow image I_2_2.

Further, the arrow image I_3_2 in the state illustrated in FIG. 7B may be an animated arrow image linked with the animated guidance images I_A_4 and I_A_5. That is, one arrow-like visual content VC_2 may be formed as a whole by the animated guidance images I_A_4 and I_A_5 and the arrow image I_3_2.

Furthermore, the arrow image I_4_2 in the state illustrated in FIG. 7C may be an animated arrow image linked with the animated guidance images I_A_6, I_A_7, and I_A_8. That is, one arrow-like visual content VC_3 may be formed as a whole by the animated guidance images I_A_6, I_A_7, and I_A_8 and the arrow image I_4_2.

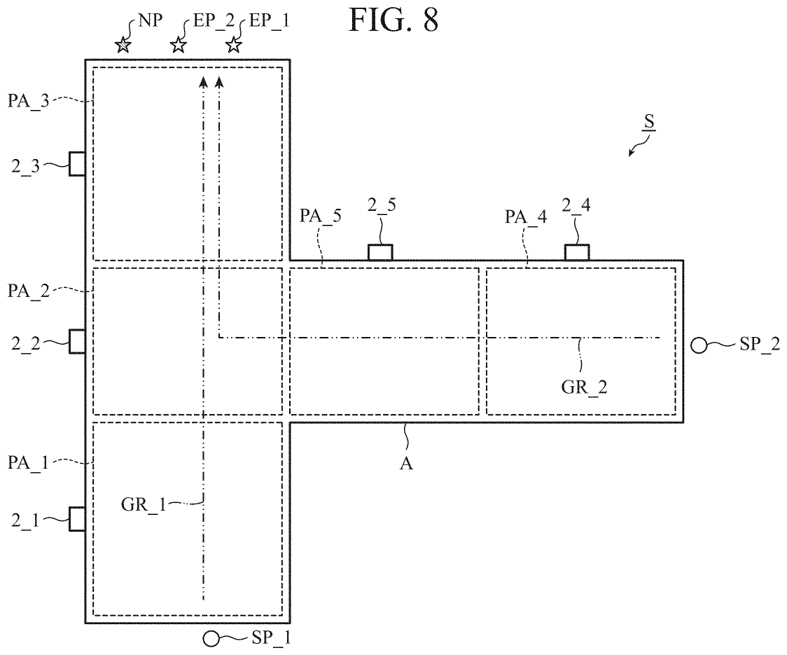

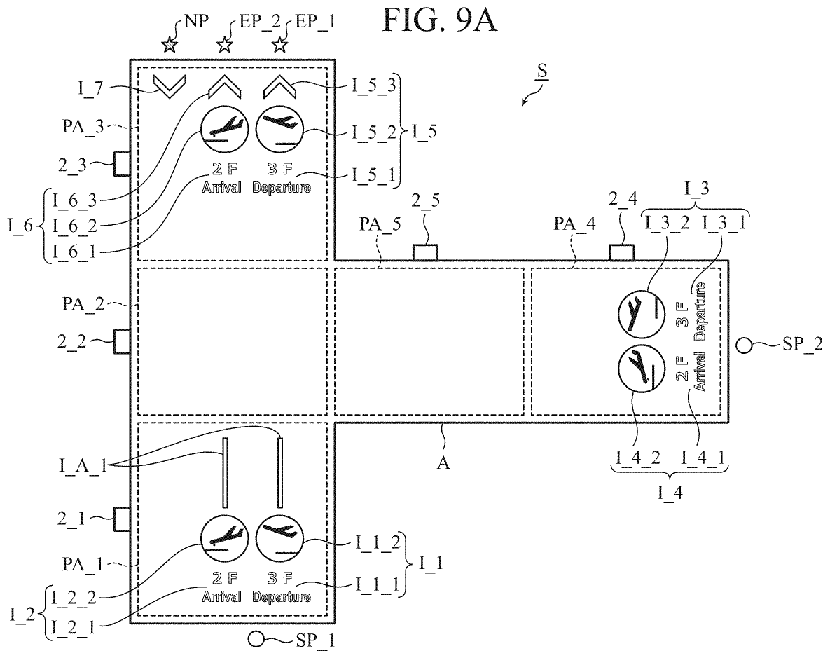

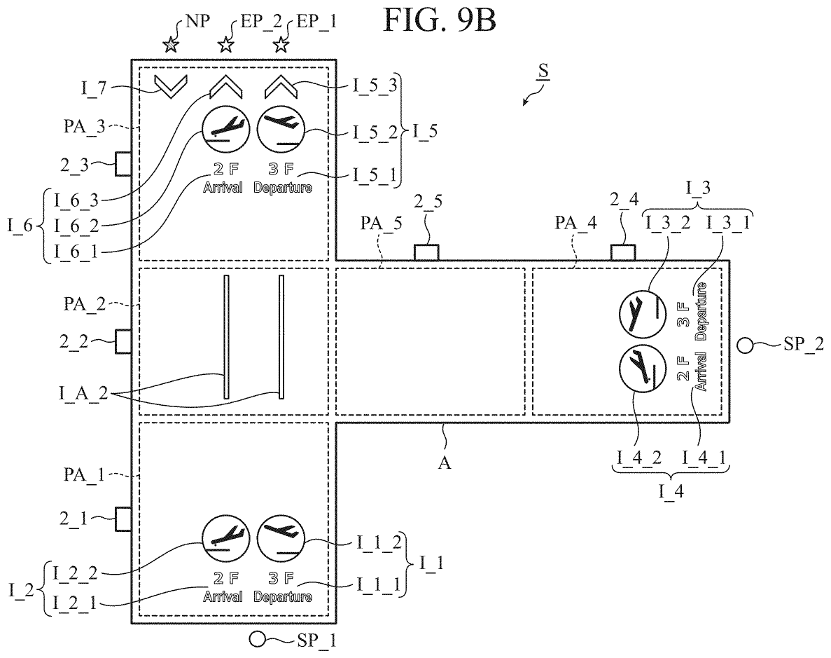

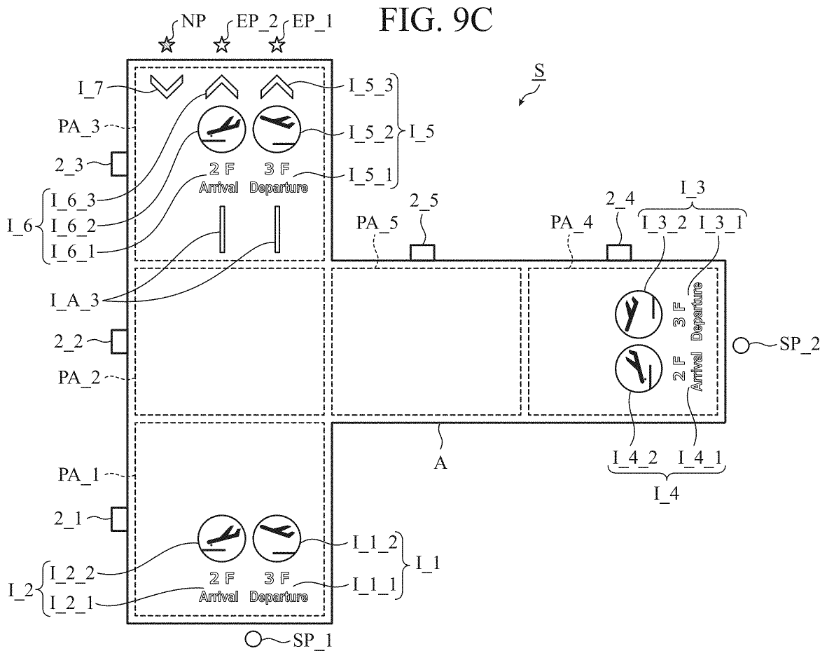

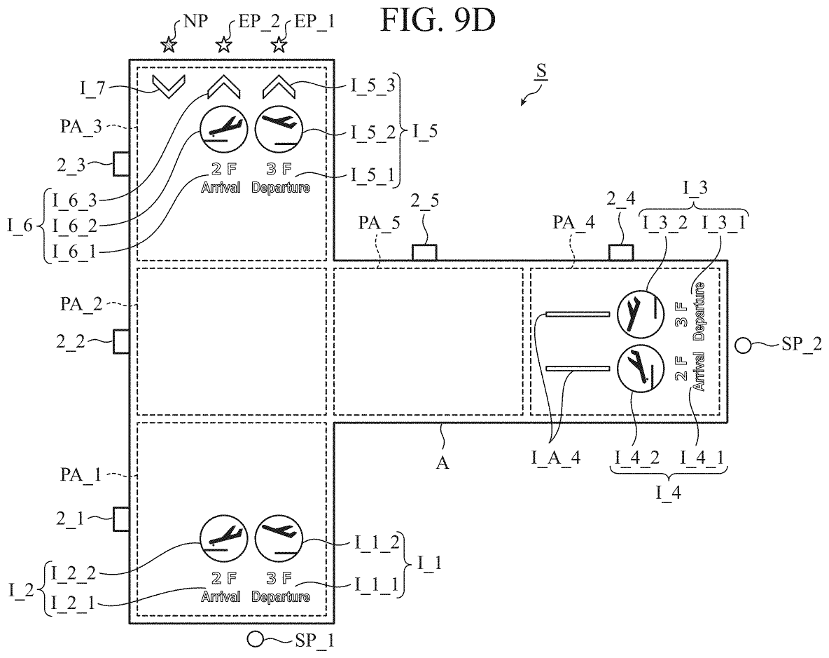

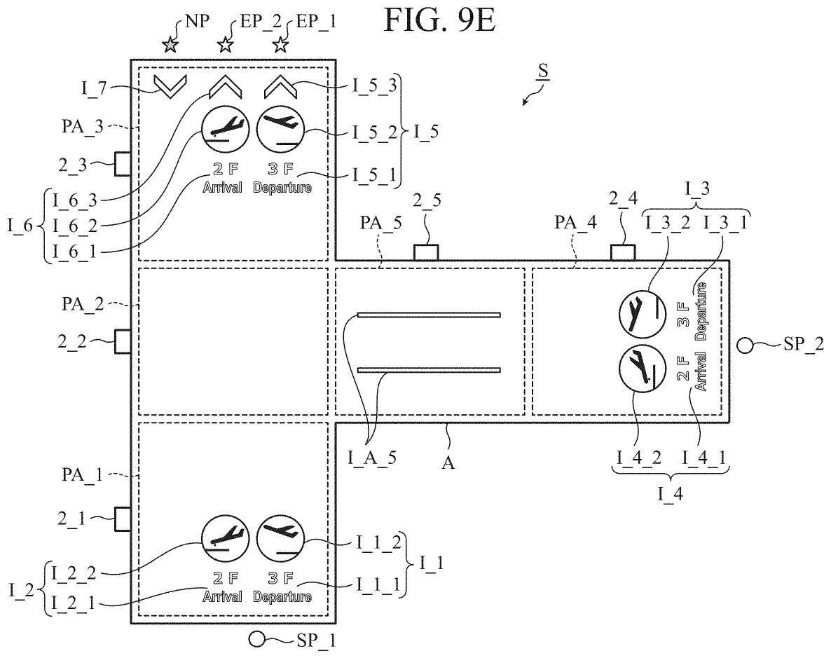

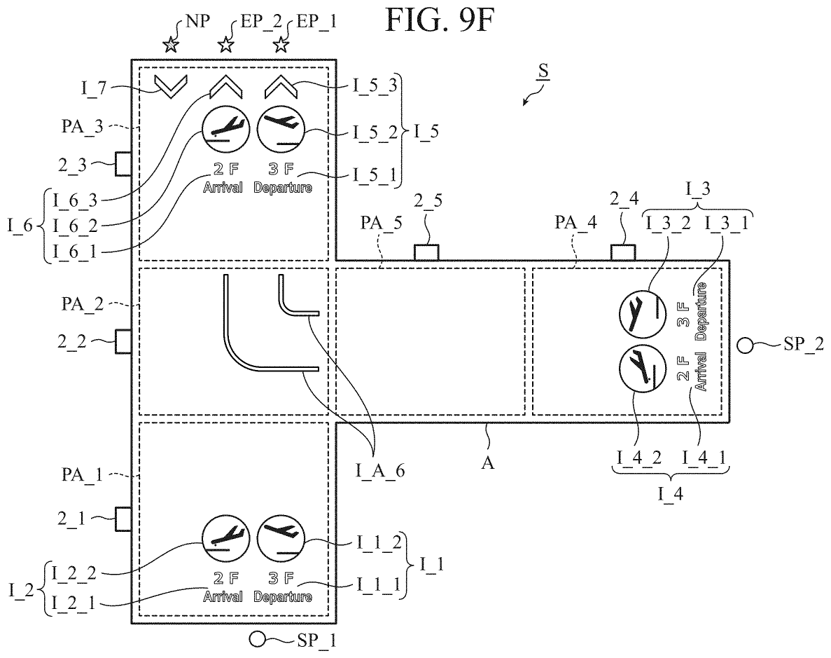

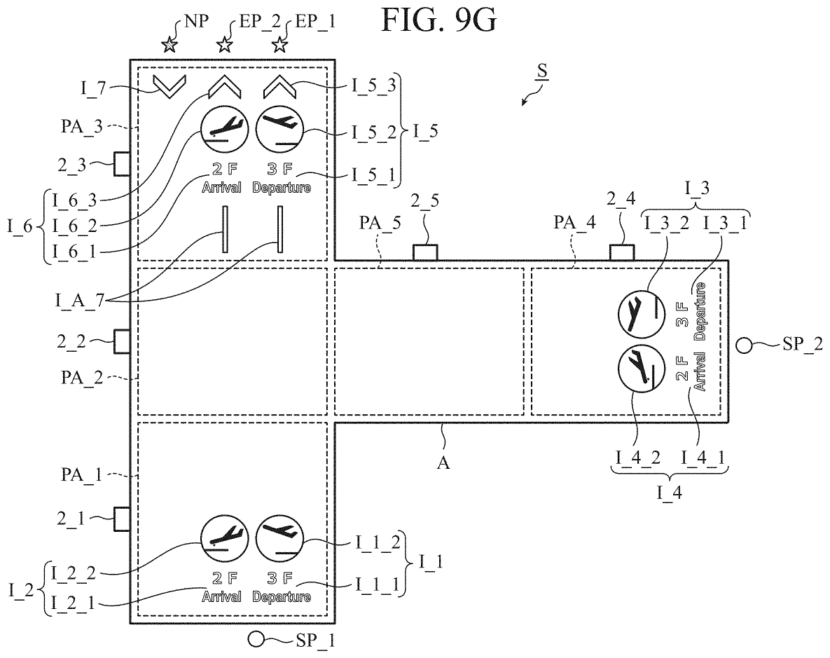

Next, another specific example of the visual content VC implemented by the guidance system 100 will be described with reference to FIGS. 8 and 9.

Now, there are an entrance on the first floor of the airport, an arrival lounge on the second floor of the airport, and a departure lounge on the third floor of the airport. In addition, a plurality of escalators are installed in the airport. The plurality of escalators include a first escalator, a second escalator, and a third escalator. The first escalator is an up escalator for moving from the entrance to the departure lounge. The second escalator is an up escalator for moving from the entrance to the arrival lounge. The third escalator is a down escalator for moving from the arrival lounge to the entrance. Consequently, there are the entrance of the first escalator, the entrance of the second escalator, and the exit of the third escalator at the entrance. The guidance target space S in the example illustrated in FIGS. 8 and 9 is a space in the airport entrance.

As illustrated in FIG. 8, two guidance routes GR_1, and GR_2 are set in the guidance target space S. The guidance routes GR_1 and GR_2 correspond to guidance start point SP_1 and SP_2, respectively. The guidance routes GR_1 and GR_2 correspond to guidance target points EP_1 and EP_2, respectively. The guidance target point EP_1 corresponds to the entrance of the first escalator. The guidance target point EP_2 corresponds to the entrance of the second escalator. The non-guidance target point NP corresponds to the exit of the third escalator.

In the example illustrated in FIGS. 8 and 9, the projection target area A includes five partial areas PA_1, PA_2, PA_3, PA_4, and PA_5. In the guidance target space S, five projection devices 2_1, 2_2, 2_3, 2_4, and 2_5 corresponding to the five partial areas PA_1, PA_2, PA_3, PA_4, and PA_5 on a one-to-one basis are installed.

The individual partial areas PA_1, PA_2, PA_3, PA_4, and PA_5 are set on the floor surface portion F. Three partial areas PA_1, PA_2, and PA_3 of the five partial areas PA_1, PA_2, PA_3, PA_4, and PA_5 are arranged along the guidance route GR_1. In addition, four partial areas PA_4, PA_5, PA_2, and PA_3 of the five partial areas PA_1, PA_2, PA_3, PA_4, and PA_5 are arranged along the guidance route GR_2.

First, the projection control unit 54 executes projection control in such a manner that the state illustrated in FIGS. 9A to 9C continues for the predetermined time T. Next, the projection control unit 54 executes the projection control in such a manner that the state illustrated in FIGS. 9D to 9G continues for the predetermined time T. Thereafter, the projection control unit 54 repeatedly executes such projection control. That is, such projection control is executed at the predetermined period Δ.

The state illustrated in FIGS. 9A to 9C is a state corresponding to the guidance with the guidance route GR_1. The state illustrated in FIGS. 9D to 9G is a state corresponding to the guidance with the guidance route GR_2.

As illustrated in each of FIGS. 9A to 9G, guidance images I_1 and I_2 are projected at a position corresponding to the guidance start point SP_1 in the partial area PA_1. The guidance image I_1 includes a text image I_1_1 and an icon image I_1_2. The guidance image I_2 includes a text image I_2_1 and an icon image I_2_2. The text image I_1_1 includes a Japanese character string that means “3F departure”. The icon image I_1_2 includes a pictogram indicating “departure” in the “JIS Z8210” standard. The text image I_2_1 includes a Japanese character string that means “2F arrival”. The icon image I_2_2 includes a pictogram indicating “arrival” in the “JIS Z8210” standard.

As illustrated in each of FIGS. 9A to 9G, guidance images I_3 and I_4 are projected at a position corresponding to the guidance start point SP_2 in the partial area PA_4. The guidance image I_3 includes a text image I_3_1 and an icon image I_3_2. The guidance image I_4 includes a text image I_4_1 and an icon image I_4_2. The images I_3_1, I_3_2, I_4_1, and I_4_2 are similar to I_1_1, I_1_2, I_2_1, and I_2_2, respectively.

As illustrated in each of FIGS. 9A to 9G, a guidance image I_5 is projected at a position corresponding to the guidance target point EP_1 in the partial area PA_3. The guidance image I_5 includes a text image I_5_1, an icon image I_5_2, and an arrow image I_5_3. The images I_5_1 and I_5_2 are similar to the images I_1_1 and I_1_2, respectively. The direction of the arrow image I_5_3 indicates that the guidance target point EP_1 is the entrance of the escalator (more specifically, the first escalator).

As illustrated in each of FIGS. 9A to 9G, a guidance image I_6 is projected at a position corresponding to the guidance target point EP_2 in the partial area PA_3. The guidance image I_6 includes a text image I_6_1, an icon image I_6_2, and an arrow image I_6_3. The images I_6_1 and I_6_2 are similar to the images I_2_1 and I_2_2, respectively. The direction of the arrow image I_6_3 indicates that the guidance target point EP_2 is the entrance of the escalator (more specifically, the second escalator).

As illustrated in each of FIGS. 9A to 9G, a guidance image I_7 is projected at a position corresponding to the non-guidance target point NP in the partial area PA_3. The guidance image I_7 includes an arrow image. The direction of the arrow image indicates that the non-guidance target point NP is the exit of the escalator (more specifically, the third escalator).

Here, in the state illustrated in FIGS. 9A to 9C, animated guidance images I_A_1, I_A_2, and I_A_3 are projected by the projection devices 2_1, 2_2, and 2_3, respectively. The animated guidance images I_A_1, I_A_2, and I_A_3 are sequentially projected for the predetermined time t. In addition, the animated guidance images I_A_1, I_A_2, and I_A_3 are repeatedly projected for the predetermined time T. The visual content VC_1 is formed by the cooperation of the animated guidance images I_A_1, I_A_2, and I_A_3. The visual content VC_1 is visually recognized, for example, as if two linear images are moving along the guidance route GR_1.

With such cooperation, guidance with the guidance route GR_1 across the partial areas PA_1, PA_2, and PA_3 can be implemented. That is, guidance over a long distance can be implemented. In addition, it is possible to cause the guidance target person to visually recognize that the animated guidance images I_A_1, I_A_2, and I_A_3 relate to a series of guidance even though a simple unit image (that is, two linear images) is used.

Furthermore, in the state illustrated in FIGS. 9D to 9G, animated guidance images I_A_4, I_A_5, I_A_6, and I_A_7 are projected by the projection devices 2_4, 2_5, 2_2, and 2_3, respectively. The animated guidance images I_A_4, I_A_5, I_A_6, and I_A_7 are sequentially projected for the predetermined time t. In addition, the animated guidance images I_A_4, I_A_5, I_A_6, and I_A_7 are repeatedly projected for the predetermined time T. The visual content VC_2 is formed by the cooperation of the animated guidance images I_A_4, I_A_5, I_A_6, and I_A_7. The visual content VC_2 is visually recognized, for example, as if two linear images are moving along the guidance route GR_2.

With such cooperation, guidance with the guidance route GR_2 across the partial areas PA_4, PA_5,PA_2, and PA_3 can be implemented. That is, guidance over a long distance can be implemented. In addition, it is possible to cause the guidance target person to visually recognize that the animated guidance images I_A_4, I_A_5, I_A_6, and I_A_7 relate to a series of guidance even though a simple unit image (that is, two linear images) is used.

Here, in the state illustrated in FIGS. 9A to 9C, each of the arrow images I_5_3 and I_6_3 may be an animated arrow image linked with the animated guidance images I_A_1, I_A_2, and I_A_3. That is, two arrow-like visual contents VC_1 may be formed as a whole by the animated guidance images I_A_1, I_A_2, and I_A_3 and the arrow images I_5_3 and I_6_3.

Furthermore, in the state illustrated in FIGS. 9D to 9G, each of the arrow images I_5_3 and I_6_3 may be an animated arrow image linked with the animated guidance images I_A_4, I_A_5, I_A_6, and I_A_7. That is, two arrow-like visual contents VC_2 may be formed as a whole by the animated guidance images I_A_4, I_A_5, I_A_6, and I_A_7 and the arrow images I_5_3 and I_6_3.

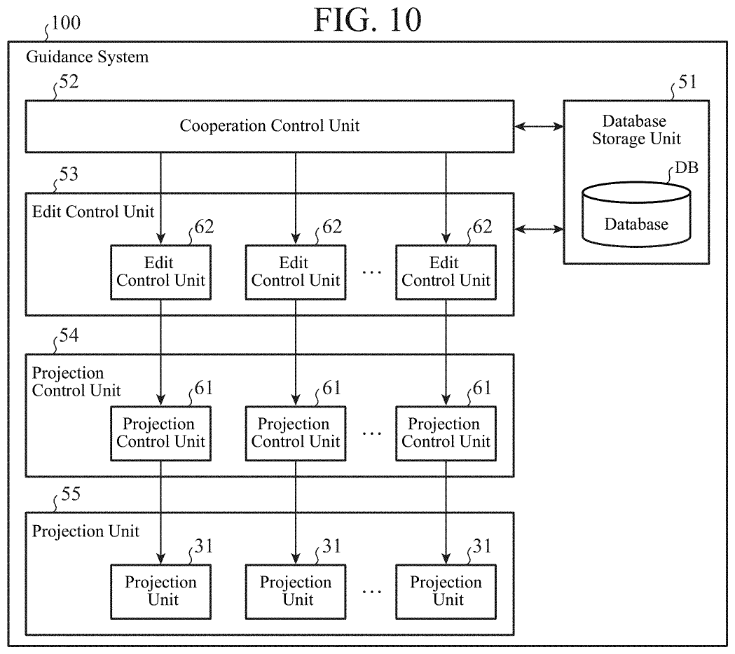

Next, a modification of the guidance system 100 will be described with reference to FIG. 10.

As illustrated in FIG. 10, the edit control unit 53 may include a plurality of edit control units 62. The plurality of edit control units 62 correspond to the plurality of projection devices 2 on a one-to-one basis.

The function of each of the plurality of edit control units 62 is implemented by, for example, the control unit 33 of the corresponding one of the plurality of projection devices 2 (see FIG. 3). In other words, each of the plurality of edit control units 62 is provided in the corresponding one of the plurality of projection devices 2. That is, the plurality of edit control units 62 are each provided in the plurality of projection devices 2.

In this case, the cooperation control unit 52 may allocate one or more guidance images I of a plurality of guidance images Ito be generated to each of the plurality of projection devices 2 before the edit control is executed (that is, before the plurality of guidance images I are generated). Further, each of the plurality of edit control units 62 may generate one or more allocated guidance images I.

Next, another modification of the guidance system 100 will be described.

The unit image in each visual content VC is not limited to one linear image or a plurality of linear images. The unit image in each visual content VC may be an image based on any mode. For example, the unit image in each visual content VC may be an arrow image.

In addition, each visual content VC is not limited to the one using the unit image. For example, each visual content VC may use two or more animated guidance images I_A generated as follows.

That is, one or more edit images I′ indicated by one or more edit image data ID′ selected by the cooperation control unit 52 may include at least one animated image (hereinafter, referred to as “animated edit image”) I′_A. The edit control unit 53 may generate two or more animated guidance images I_A corresponding to the individual guidance routes GR by dividing the animated edit image I′_A. In other words, the edit control may include control to generate two or more animated guidance images I_A corresponding to the individual guidance routes GR by dividing the animated edit image I′_A.

Here, the animated edit image I′_A is not limited to an animated image using the unit image. The animated edit image I′_A may use any animated image. As a result, it is possible to implement the visual content VC based on various modes while ensuring the continuity of two or more animated guidance images I_A in the individual guidance routes GR.

Next, yet another modification of the guidance system 100 will be described.

The number of the partial areas PA along each guidance route GR is not limited to the examples illustrated in FIGS. 6 to 9 (that is, two, three, or four). The number may be set to a number depending on the length of each guidance route GR.

For example, when the length of a certain guidance route GR is less than or equal to 20 m, three or less partial areas PA may be arranged along the guidance route GR. In addition, for example, when the length of a certain guidance route GR is less than or equal to 40 m, four partial areas PA may be arranged along the guidance route GR.

Furthermore, the shape in which the partial areas PA are arranged is not limited to the example illustrated in FIGS. 6 and 7 (that is, an I-shape) or the example illustrated in FIGS. 8 and 9 (that is, a T-shape). The partial areas PA for a certain guidance route GR are only required to be arranged in a shape corresponding to the shape of the guidance route GR.

As described above, the guidance system 100 according to the first embodiment includes the projection device group 3 that projects the guidance image group IG onto the projection target area A in the guidance target space S, the projection target area A includes a plurality of partial areas PA, the projection device group 3 includes a plurality of projection devices 2 corresponding to the plurality of partial areas PA, the guidance image group IG includes two or more animated guidance images I_A, and each of two or more of the plurality of projection devices 2 projects each of two or more animated guidance images I_A, so that the continuous visual content VC for guidance is formed by the cooperation of the two or more animated guidance images I_A. As a result, it is possible to implement guidance with the guidance route GR across two or more partial areas PA. That is, guidance over a long distance can be implemented. In addition, it is possible to cause a guidance target person to visually recognize that two or more animated guidance images I_A relate to a series of guidance.

Furthermore, the guidance system 100 includes the edit control unit 53 that executes control to edit the guidance image group IG, and the control executed by the edit control unit 53 includes control to generate two or more animated guidance images I_A by dividing the animated edit image I′_A. As a result, it is possible to implement the visual content VC based on various modes while ensuring the continuity of two or more animated guidance images I_A.

Moreover, the edit control unit 53 includes a plurality of edit control units 62, and the plurality of edit control units 62 are each provided in the plurality of projection devices 2. As a result, it is possible to execute edit control for each projection device 2.

In addition, two or more partial areas PA corresponding to two or more animated guidance images I_A among the plurality of partial areas PA are arranged along the guidance route GR corresponding to the visual content VC, and the number of the two or more partial areas PA is set to a number depending on the length of the guidance route GR. The number of the partial areas PA can be set to an appropriate number depending on the length of the guidance route GR.

Furthermore, the visual content VC is visually recognized as if the predetermined number of unit images with a predetermined shape are moving along the guidance route GR corresponding to the visual content VC. As a result, a simple visual content VC can be implemented.

Further, the unit image includes one linear image or a plurality of linear images. By using such a simple unit image, a simpler visual content VC can be implemented.

In addition, the visual content VC is formed for the predetermined time T by repeatedly projecting two or more animated guidance images I_A. As a result, for example, the visual content VC illustrated in FIG. 7 or 9 can be implemented.

Furthermore, the guidance method according to the first embodiment is a guidance method using the projection device group 3 that projects the guidance image group IG onto the projection target area A in the guidance target space S, the projection target area A includes a plurality of partial areas PA, the projection device group 3 includes a plurality of projection devices 2 corresponding to the plurality of partial areas PA, the guidance image group IG includes two or more animated guidance images I_A, and each of two or more of the plurality of projection devices 2 projects each of two or more animated guidance images I_A, so that the continuous visual content VC for guidance is formed by the cooperation of the two or more animated guidance images I_A. As a result, it is possible to implement guidance with the guidance route GR across two or more partial areas PA. That is, guidance over a long distance can be implemented. In addition, it is possible to cause the guidance target person to visually recognize that two or more animated guidance images I_A relate to a series of guidance.

### Second Embodiment

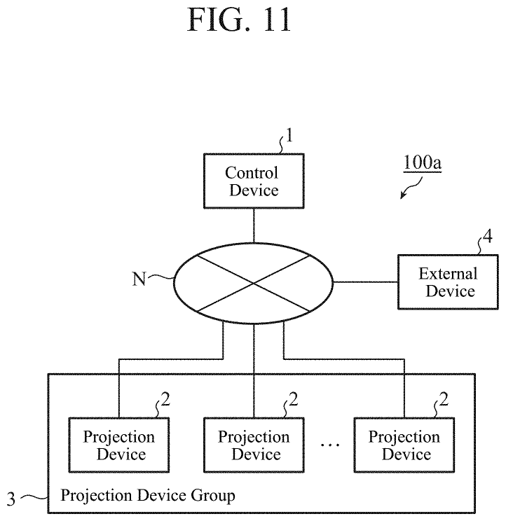

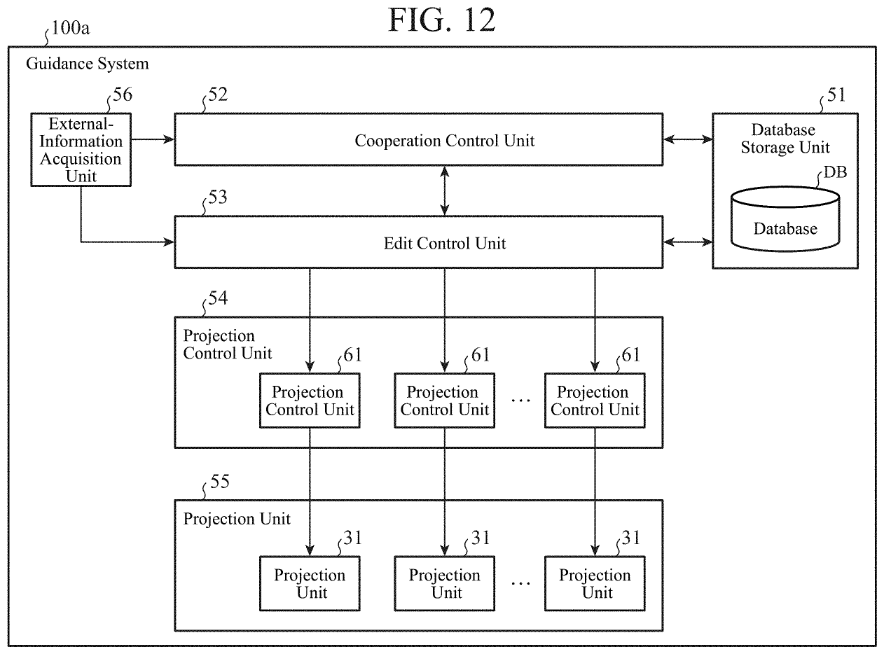

FIG. 11 is a block diagram illustrating a system configuration of a guidance system according to a second embodiment. FIG. 12 is a block diagram illustrating a functional configuration of the guidance system according to the second embodiment. The guidance system according to the second embodiment will be described with reference to FIGS. 11 and 12. Note that, in FIG. 11, the same reference numerals are given to blocks similar to those illustrated in FIG. 1, and the description thereof will be omitted. Furthermore, in FIG. 12, the same reference numerals are given to blocks similar to those illustrated in FIG. 4, and the description thereof will be omitted.

As illustrated in FIG. 11, a guidance system 100a includes the control device 1 and a plurality of projection devices 2. The configuration of the control device 1 is similar to that described in the first embodiment with reference to FIG. 2. The configuration of each projection device 2 is similar to that described in the first embodiment with reference to FIG. 3. These configurations will not be described again.

In addition to these components, the guidance system 100a includes an external device 4. The external device 4 includes, for example, a dedicated terminal device installed in the guidance target space S, various sensors (for example, human sensors) installed in the guidance target space S, a camera installed in the guidance target space S, a control device for a system (for example, an information management system) different from the guidance system 100a, or a mobile information terminal (for example, a tablet computer) possessed by a guidance target person. The external device 4 is communicable with the control device 1 by the computer network N. In other words, the control device 1 is communicable with the external device 4 by the computer network N.

As illustrated in FIG. 12, the guidance system 100a includes the database storage unit 51, the cooperation control unit 52, the edit control unit 53, the projection control unit 54, and the projection unit 55. In addition, the guidance system 100a includes an external-information acquisition unit 56. The function of the external-information acquisition unit 56 is implemented by, for example, the communication unit 12 of the control device 1. In other words, the external-information acquisition unit 56 is provided in the control device 1, for example.

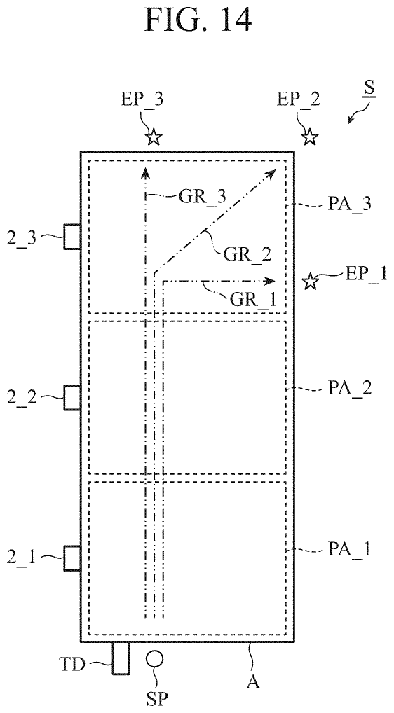

The external-information acquisition unit 56 acquires information (hereinafter referred to as “external information”) output by the external device 4. For the cooperation control and the edit control, the acquired external information is used in addition to the control information. Specific examples of the external device 4, the external information, and the visual content VC based on the external information will be described later with reference to FIGS. 14 to 26.

Hereinafter, in some cases, the process performed by the external-information acquisition unit 56 is collectively referred to as “external-information acquisition process”. That is, the external-information acquisition process includes a process of acquiring external information and the like.

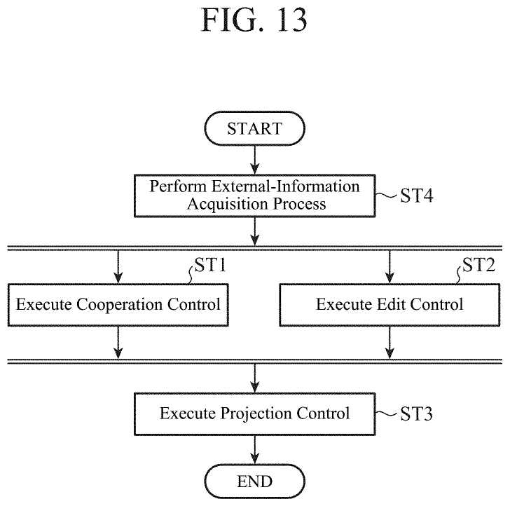

Next, an operation of the guidance system 100a will be described focusing on operations of the external-information acquisition unit 56, the cooperation control unit 52, the edit control unit 53, and the projection control unit 54 with reference to the flowchart of FIG. 13. Note that, in FIG. 13, the same reference numerals are given to steps similar to those illustrated in FIG. 5, and the description thereof is omitted.

First, the external-information acquisition unit 56 performs an external-information acquisition process (step ST4). Next, the processes of steps ST1 and ST2 are performed. The process of step ST3 is then performed.

Next, a specific example of the visual content VC implemented by the guidance system 100a will be described with reference to FIGS. 14 to 18.

Now, a terminal device TD for reception is installed in a bank. In addition, there are a plurality of counters in the bank. The counters include a first counter (“counter A” in the drawing), a second counter (“counter B” in the drawing), and a third counter (“counter C” in the drawing). The guidance target space S in the example illustrated in FIGS. 14 to 18 is a space in the bank.

As illustrated in FIG. 14, three guidance routes GR_1, GR_2, and GR_3 are set in the guidance target space S. Each of the guidance routes GR_1, GR_2, and GR_3 corresponds to the guidance start point SP. The guidance routes GR_1, GR_2, and GR_3 correspond to the guidance target points EP_1, EP_2, and EP_3, respectively. The guidance start point SP corresponds to a position where the terminal device TD is installed. The guidance target point EP_1 corresponds to the first counter. The guidance target point EP_2 corresponds to the second counter. The guidance target point EP_3 corresponds to the third counter.

The external device 4 in the example illustrated in FIGS. 14 to 18 includes the terminal device TD. The guidance target person (that is, the user of the bank) selects one counter that the guidance target person desires to use among the plurality of counters, and inputs information indicating the selected one counter to the terminal device TD. The input information is external information.

In the example illustrated in FIGS. 14 to 18, the projection target area A includes three partial areas PA_1, PA_2, and PA_3. In the guidance target space S, three projection devices 2_1, 2_2, and 2_3 corresponding to the three partial areas PA_1, PA_2, and PA_3 on a one-to-one basis are installed. The individual partial areas PA_1, PA_2, and PA_3 are set on the floor surface portion F. The three partial areas PA_1, PA_2, and PA_3 are arranged along the guidance route GR_1, the guidance route GR_2, and the guidance route GR_3.

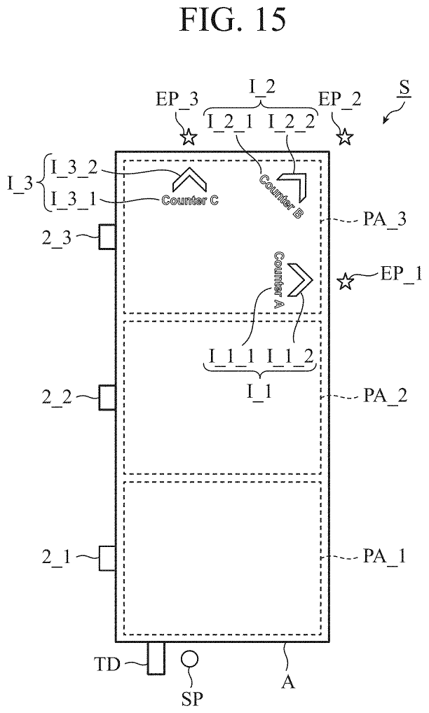

FIG. 15 illustrates an example of the guidance image group IG projected in a case where the external information is not input by the guidance target person (that is, a case where the external information is not acquired by the external-information acquisition unit 56).

As illustrated in FIG. 15, a guidance image I_1 is projected at a position corresponding to the guidance target point EP_1 in the partial area PA_3. The guidance image I_1 includes a text image I_1_1 and an arrow image I_1_2. The text image I_1_1 includes a Japanese character string that means “counter A”. The arrow image I_1_2 indicates the position of the first counter.

As illustrated in FIG. 15, a guidance image I_2 is projected at a position corresponding to the guidance target point EP_2 in the partial area PA_3. The guidance image I_2 includes a text image I_2_1 and an arrow image I_2_2. The text image I_2_1 includes a Japanese character string that means “counter B”. The arrow image I_2_2 indicates the position of the second counter.

As illustrated in FIG. 15, a guidance image I_3 is projected at a position corresponding to the guidance target point EP_3 in the partial area PA_3. The guidance image I_3 includes a text image I_3_1 and an arrow image I_3_2. The text image I_3_1 includes a Japanese character string that means “counter C”. The arrow image I_3_2 indicates the position of the third counter.

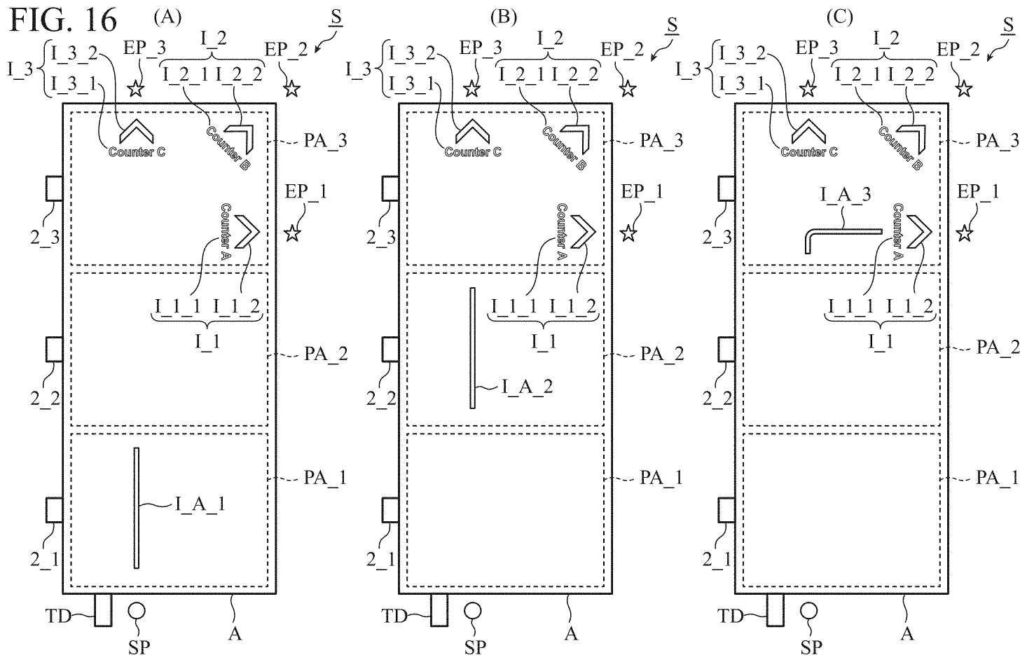

FIG. 16 illustrates an example of the guidance image group IG projected when the input external information indicates the first counter in a case where the external information is input by the guidance target person (that is, a case where the external information is acquired by the external-information acquisition unit 56). That is, the state illustrated in FIG. 16 is a state corresponding to the guidance with the guidance route GR_1.

As illustrated in FIG. 16, the guidance image I_1 is projected at the position corresponding to the guidance target point EP_1 in the partial area PA_3. Furthermore, the guidance image I_2 is projected at the position corresponding to the guidance target point EP_2 in the partial area PA_3. In addition, the guidance image I_3 is projected at the position corresponding to the guidance target point EP_3 in the partial area PA_3. The guidance images I_1, I_2, and I_3 are similar to those illustrated in FIG. 15.

Furthermore, as illustrated in FIG. 16, animated guidance images I_A_1, I_A_2, and I_A_3 are projected by the projection devices 2_1, 2_2, and 2_3, respectively. The animated guidance images I_A_1, I_A_2, and I_A_3 are sequentially projected for the predetermined time t. In addition, the animated guidance images I_A_1, I_A_2, and I_A_3 are repeatedly projected. The visual content VC is formed by the cooperation of the animated guidance images I_A_1, I_A_2, and I_A_3. The visual content VC is visually recognized, for example, as if one linear image is moving along the guidance route GR_1. With such cooperation, effects similar to those described in the first embodiment can be obtained.

Here, the arrow image I_1_2 of the guidance image I_1 illustrated in FIG. 16 may be an animated arrow image linked with the animated guidance images I_A_1, I_A_2, and I_A_3. That is, one arrow-like visual content VC may be formed as a whole by the animated guidance images I_A_1, I_A_2, and I_A_3 and the arrow image I_1_2.

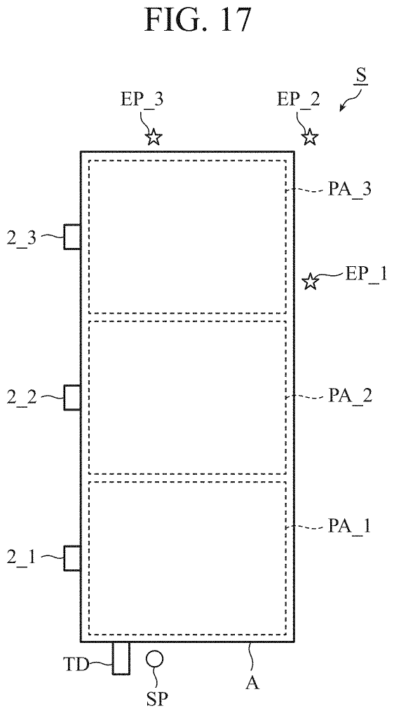

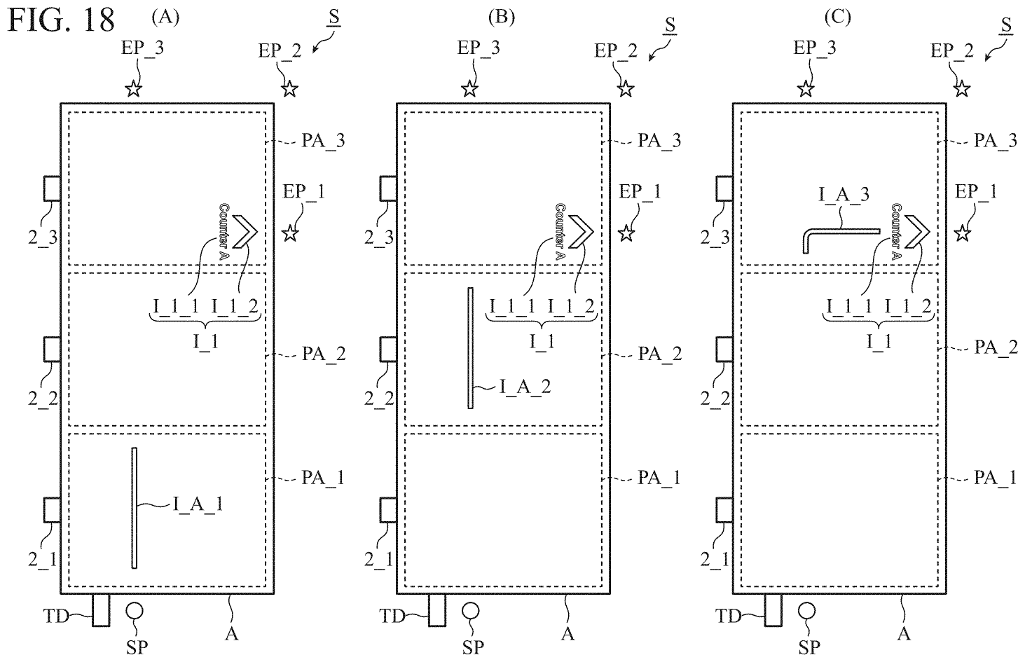

Note that in a case where the external information is not input by the guidance target person (that is, in a case where the external information is not acquired by the external-information acquisition unit 56), the projection of the guidance image group IG may be canceled. In other words, the guidance image group IG including zero guidance images I may be projected (see FIG. 17). Then, when the external information indicating the first counter is acquired, for example, the guidance image group IG illustrated in FIG. 18 may be projected.

As illustrated in FIG. 18, the guidance image I_1 is projected at the position corresponding to the guidance target point EP_1 in the partial area PA_3. The guidance image I_1 is similar to that illustrated in FIG. 16. Further, as illustrated in FIG. 18, the animated guidance images I_A_1, I_A_2, and I_A_3 are projected by the projection devices 2_1, 2_2, and 2_3, respectively. The animated guidance images I_A_1, I_A_2, and I_A_3 are similar to those illustrated in FIG. 16. As a result, effects similar to those described in the first embodiment can be obtained.

Note that illustration and description of an example of the guidance image group IG projected when the input external information indicates the second counter or the third counter in a case where the external information is input by the guidance target person (that is, a case where the external information is acquired by the external-information acquisition unit 56) will be omitted.

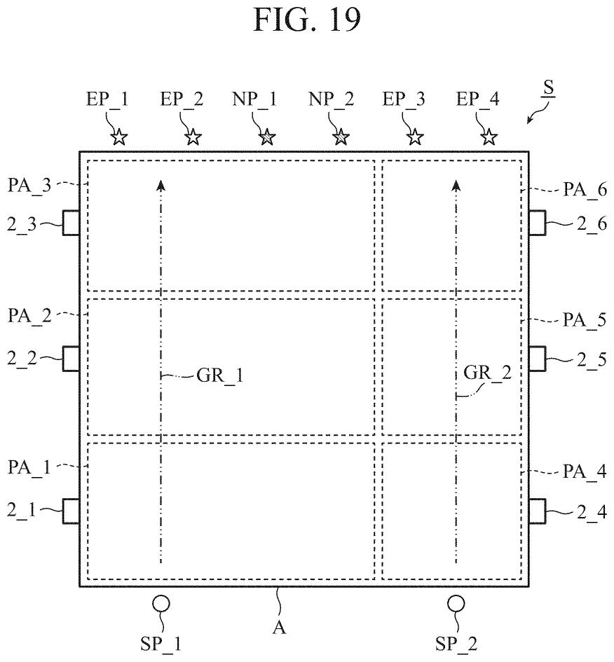

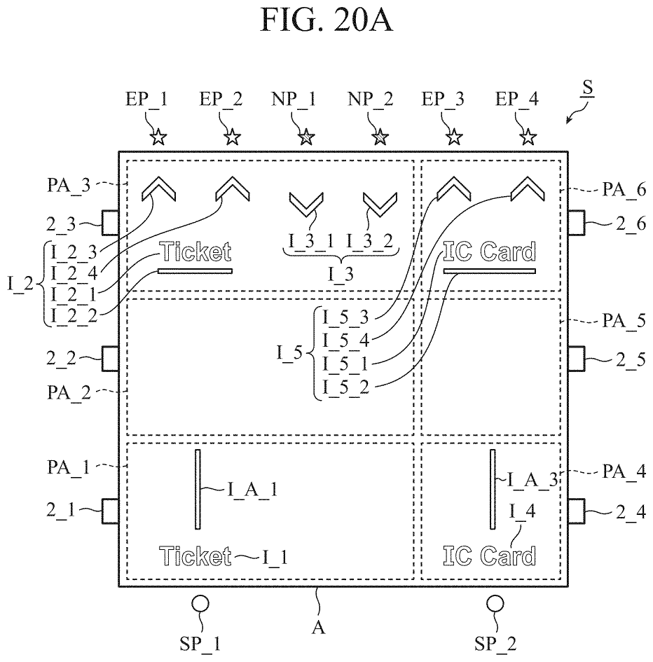

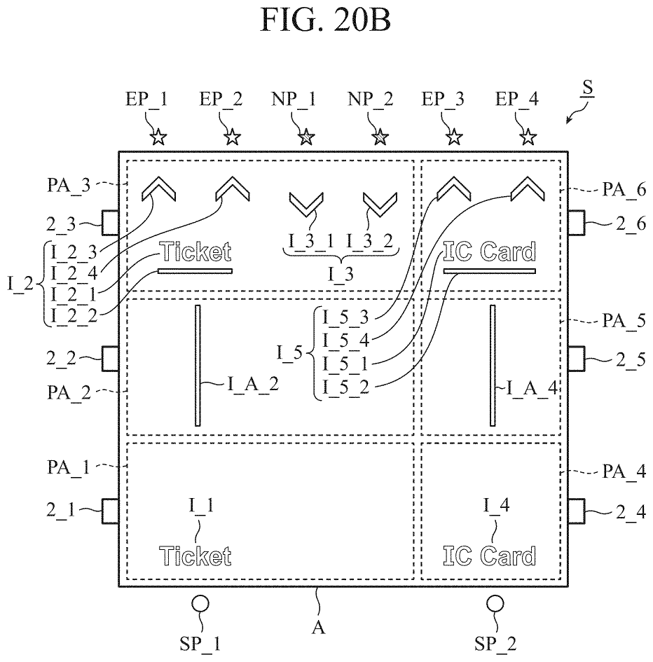

Next, another specific example of the visual content VC implemented by the guidance system 100a will be described with reference to FIGS. 19 and 20.

Now, an automatic ticket gate group is installed at a ticket gate of a station. The automatic ticket gate group includes a first automatic ticket gate, a second automatic ticket gate, a third automatic ticket gate, a fourth automatic ticket gate, a fifth automatic ticket gate, and a sixth automatic ticket gate. Each automatic ticket gate is selectively set as a ticket gate for entrance, a ticket gate for exit, or a ticket gate for entrance and exit. Each automatic ticket gate is selectively set as a ticket gate for a ticket, a ticket gate for an IC card, or a ticket gate for a ticket and an IC card. The guidance target space S in FIGS. 19 and 20 is a space inside the ticket gate of the station.

The automatic ticket gate group is controlled by a dedicated system (hereinafter, referred to as “automatic ticket-gate control system”). The external device 4 in the example illustrated in FIGS. 19 and 20 includes a control device for an automatic ticket-gate control system (hereinafter, referred to as “automatic ticket-gate control device”). The automatic ticket-gate control device has a function of outputting information indicating the setting of each automatic ticket gate. The output information is external information.

Hereinafter, an example in a case where the first automatic ticket gate and the second automatic ticket gate are set as ticket gates for exit, the third automatic ticket gate and the fourth automatic ticket gate are set as ticket gates for entrance, and the fifth automatic ticket gate and the sixth automatic ticket gate are set as ticket gates for exit will be mainly described. In addition, an example in a case where the first automatic ticket gate and the second automatic ticket gate are set as ticket gates for a ticket, and the fifth automatic ticket gate and the sixth automatic ticket gate are set as ticket gates for an IC card will be mainly described. That is, an example in a case where external information indicating these settings is acquired will be mainly described.

In this case, as illustrated in FIG. 19, two guidance routes GR_1 and GR_2 are set in the guidance target space S. The guidance route GR_1 corresponds to the guidance start point SP_1, and the guidance target points EP_1 and EP_2. The guidance route GR_2 corresponds to the guidance start point SP_2, and the guidance target points EP_3 and EP_4.

The guidance target point EP_1 corresponds to the first automatic ticket gate. The guidance target point EP_2 corresponds to the second automatic ticket gate. The guidance target point EP_3 corresponds to the fifth automatic ticket gate. The guidance target point EP_4 corresponds to the sixth automatic ticket gate. Further, the non-guidance target point NP_1 corresponds to the third automatic ticket gate. The non-guidance target point NP_2 corresponds to the fourth automatic ticket gate.

In the example illustrated in FIGS. 19 and 20, the projection target area A includes six partial areas PA_1, PA_2, PA_3, PA_4, PA_5, and PA_6. In the guidance target space S, six projection devices 2_1, 2_2, 2_3, 2_4, 2_5, and 2_6 corresponding to the six partial areas PA_1, PA_2, PA_3, PA_4, PA_5, and PA_6 on a one-to-one basis are installed. The individual partial areas PA_1, PA_2, PA_3, PA_4, PA_5, and PA_6 are set on the floor surface portion F. Three partial areas PA_1, PA_2, and PA_3 of the six partial areas PA_1, PA_2, PA_3, PA_4, PA_5, and PA_6 are arranged along the guidance route GR_1. In addition, three partial areas PA_4, PA_5, and PA_6 of the six partial areas PA_1, PA_2, PA_3, PA_4, PA_5, and PA_6 are arranged along the guidance route GR_2.

As illustrated in FIG. 20, a guidance image I_1 is projected at a position corresponding to the guidance start point SP_1 in the partial area PA_1. The guidance image I_1 includes a text image. The text image includes a Japanese character string that means “ticket”.

Further, as illustrated in FIG. 20, a guidance image I_2 is projected at a position corresponding to the guidance target points EP_1 and EP_2 in the partial area PA_3. The guidance image I_2 includes a text image I_2_1, an underline image I_2_2 for the text image I_2_1, an arrow image I_2_3 corresponding to the guidance target point EP_1, and an arrow image I_2_4 corresponding to the guidance target point EP_2. The text image I_2_1 includes the Japanese character string that means “ticket”. The direction of the arrow image I_2_3 indicates that the first automatic ticket gate is set as a ticket gate for exit. The direction of the arrow image I_2_4 indicates that the second automatic ticket gate is set as a ticket gate for exit.

In addition, as illustrated in FIG. 20, a guidance image I_3 is projected at a position corresponding to the non-guidance target points NP_1 and NP_2 in the partial area PA_3. The guidance image I_3 includes an arrow image I_3_1 corresponding to the non-guidance target point NP_1 and an arrow image I_3_2 corresponding to the non-guidance target point NP_2. The direction of the arrow image I_3_1 indicates that the third automatic ticket gate is set as a ticket gate for entrance. The direction of the arrow image I_3_2 indicates that the fourth automatic ticket gate is set as a ticket gate for entrance.

As illustrated in FIG. 20, a guidance image I_4 is projected at a position corresponding to the guidance start point SP_2 in the partial area PA_4. The guidance image I_4 includes a text image. The text image includes a Japanese character string that means “IC card”.

Further, as illustrated in FIG. 20, a guidance image I_5 is projected at a position corresponding to the guidance target points EP_3 and EP_4 in the partial area PA_6. The guidance image I_5 includes a text image I_5_1, an underline image I_5_2 for the text image I_5_1, an arrow image I_5_3 corresponding to the guidance target point EP_3, and an arrow image I_5_4 corresponding to the guidance target point EP_4. The image I_5_1 includes the Japanese character string that means “IC card”. The direction of the arrow image I_5_3 indicates that the fifth automatic ticket gate is set as a ticket gate for exit. The direction of the arrow image I_5_4 indicates that the sixth automatic ticket gate is set as a ticket gate for exit.

Furthermore, as illustrated in FIG. 20, animated guidance images I_A_1 and I_A_2 are projected by the projection devices 2_1 and 2_2, respectively. The animated guidance images I_A_1 and I_A_2 are sequentially projected for the predetermined time t. In addition, the animated guidance images I_A_1 and I_A_2 are repeatedly projected. The visual content VC_1 is formed by the cooperation of the animated guidance images I_A_1 and I_A_2. The visual content VC_1 is visually recognized, for example, as if one linear image is moving along the guidance route GR_1. With such cooperation, effects similar to those described in the first embodiment can be obtained.

Furthermore, as illustrated in FIG. 20, animated guidance images I_A_3 and I_A_4 are projected by the projection devices 2_4 and 2_5, respectively. The animated guidance images I_A_3 and I_A_4 are sequentially projected for the predetermined time t. In addition, the animated guidance images I_A_3 and I_A_4 are repeatedly projected. The visual content VC_2 is formed by the cooperation of the animated guidance images I_A_3 and I_A_4. The visual content VC_2 is visually recognized, for example, as if one linear image is moving along the guidance route GR_2. With such cooperation, effects similar to those described in the first embodiment can be obtained.

Here, the arrow images I_2_3 and I_2_4 may be an animated arrow image linked with the animated guidance images I_A_1 and I_A_2. Further, the arrow images I_5_3 and I_5_4 may be an animated arrow image linked with the animated guidance images I_A_3 and I_A_4.

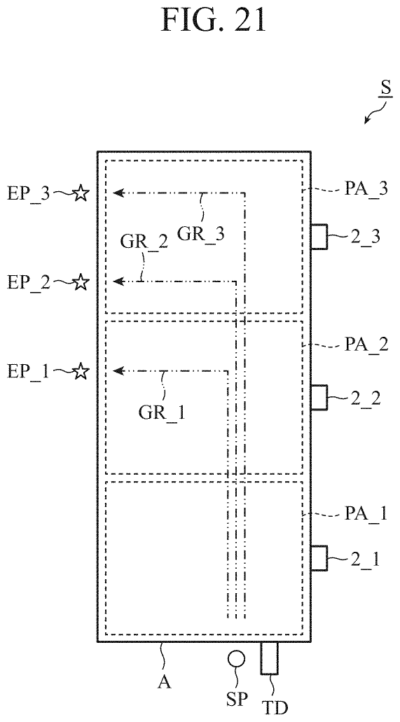

Next, another specific example of the visual content VC implemented by the guidance system 100a will be described with reference to FIGS. 21 to 24.

Now, an elevator group is installed in an office building. The elevator group includes a first elevator (“A” in the drawing), a second elevator (“B” in the drawing), and a third elevator (“C” in the drawing). Here, the elevator group is controlled by a destination oriented allocation system (DOAS). The external device 4 in the example illustrated in FIGS. 21 to 24 includes a control device for DOAS (hereinafter, referred to as “elevator control device”).

That is, the terminal device TD for DOAS is installed in the elevator hall of the office building. The terminal device TD is communicable with the elevator control device. The guidance target person (that is, the user of the elevator group) inputs information indicating the destination floor of the guidance target person to the terminal device TD before getting on any one of the elevators. Note that the input of such information may be implemented by the terminal device TD reading data recorded on an IC card (for example, an employee ID card) possessed by the guidance target person.

The elevator control device acquires the input information. The elevator control device selects one elevator to be used by the guidance target person among the plurality of elevators included in the elevator group using the acquired information. The elevator control device controls the elevator group on the basis of the selection result. At this time, the elevator control device has a function of outputting information indicating the selection result. The output information is external information.

As illustrated in FIG. 21, three guidance routes GR_1, GR_2, and GR_3 are set in the guidance target space S. Each of the guidance routes GR_1, GR_2, and GR_3 corresponds to the guidance start point SP. The guidance routes GR_1, GR_2, and GR_3 correspond to the guidance target points EP_1, EP_2, and EP_3, respectively. The guidance start point SP corresponds to a position where the terminal device TD is installed. The guidance target point EP_1 corresponds to the first elevator. The guidance target point EP_2 corresponds to the second elevator. The guidance target point EP_3 corresponds to the third elevator.

In the example illustrated in FIGS. 21 to 24, the projection target area A includes three partial areas PA_1, PA_2, and PA_3. In the guidance target space S, three projection devices 2_1, 2_2, and 2_3 corresponding to the three partial areas PA_1, PA_2, and PA_3 on a one-to-one basis are installed. The individual partial areas PA_1, PA_2, and PA_3 are set on the floor surface portion F. Two partial areas PA_1 and PA_2 of the three partial areas PA_1, PA_2, and PA_3 are arranged along the guidance route GR_1. In addition, the three partial areas PA_1, PA_2, and PA_3 are arranged along the guidance route GR_2 and the guidance route GR_3.

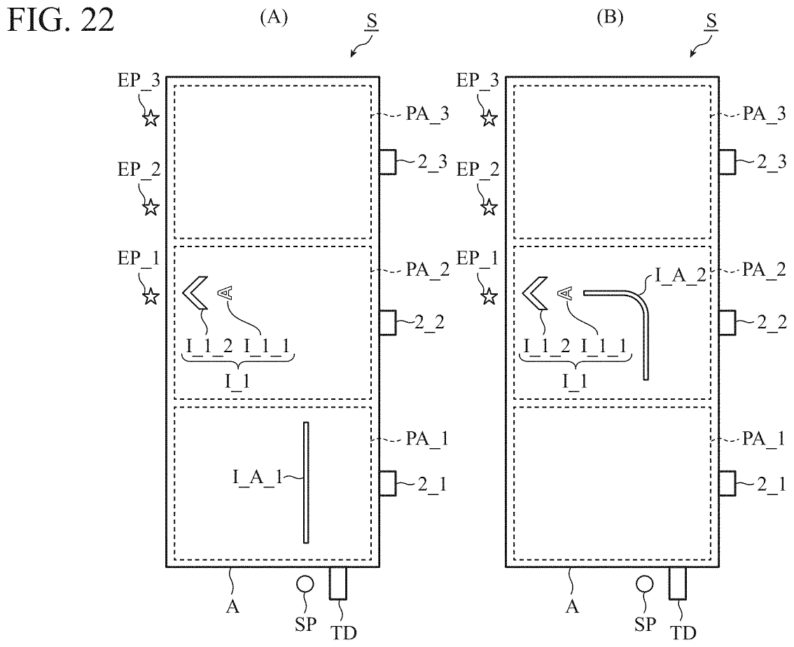

FIG. 22 illustrates an example of the guidance image group IG projected when the external information indicating that the first elevator is selected is acquired. That is, the state illustrated in FIG. 22 is a state corresponding to the guidance with the guidance route GR_1.

As illustrated in FIG. 22, a guidance image I_1 is projected at a position corresponding to the guidance target point EP_1 in the partial area PA_2. The guidance image I_1 includes a text image I_1_1 and an arrow image I_1_2. The text image I_1_1 includes a character “A”. The arrow image I_1_2 indicates the position of the first elevator.

Furthermore, as illustrated in FIG. 22, animated guidance images I_A_1 and I_A_2 are projected by the projection devices 2_1 and 2_2, respectively. The animated guidance images I_A_1 and I_A_2 are sequentially projected for the predetermined time t. In addition, the animated guidance images I_A_1 and I_A_2 are repeatedly projected. The visual content VC_1 is formed by the cooperation of the animated guidance images I_A_1 and I_A_2. The visual content VC_1 is visually recognized, for example, as if one linear image is moving along the guidance route GR_1. With such cooperation, effects similar to those described in the first embodiment can be obtained.

Here, the arrow image I_1_2 may be an animated arrow image linked with the animated guidance images I_A_1 and I_A_2. That is, one arrow-like visual content VC_1 may be formed as a whole by the animated guidance images I_A_1 and I_A_2 and the arrow image I_1_2.

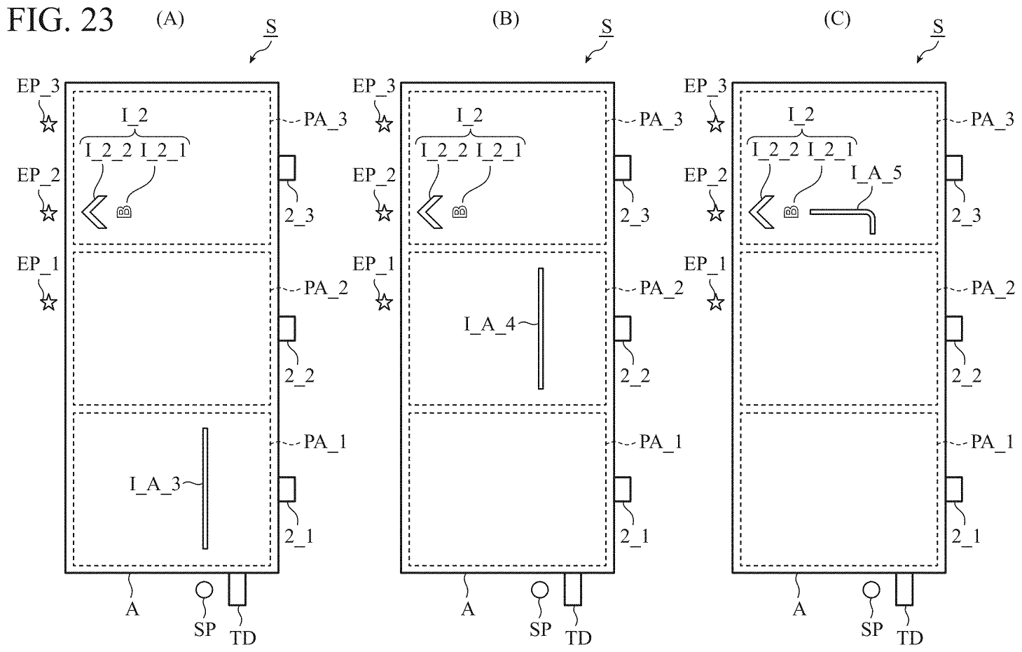

FIG. 23 illustrates an example of the guidance image group IG projected when the external information indicating that the second elevator is selected is acquired. That is, the state illustrated in FIG. 23 is a state corresponding to the guidance with the guidance route GR_2.

As illustrated in FIG. 23, a guidance image I_2 is projected at a position corresponding to the guidance target point EP_2 in the partial area PA_3. The guidance image I_2 includes a text image I_2_1 and an arrow image I_2_2. The text image I_2_1 includes a character “B”. The arrow image I_2_2 indicates the position of the second elevator.

Further, as illustrated in FIG. 23, animated guidance images I_A_3, I_A_4, and I_A_5 are projected by the projection devices 2_1, 2_2, and 2_3, respectively. The animated guidance images I_A_3, I_A_4, and I_A_5 are sequentially projected for the predetermined time t. In addition, the animated guidance images I_A_3, I_A_4, and I_A_5 are repeatedly projected. The visual content VC_2 is formed by the cooperation of the animated guidance images I_A_3, I_A_4, and I_A_5. The visual content VC_2 is visually recognized, for example, as if one linear image is moving along the guidance route GR_2. With such cooperation, effects similar to those described in the first embodiment can be obtained.

Here, the arrow image I_2_2 may be an animated arrow image linked with the animated guidance images I_A_3, I_A_4, and I_A_5. That is, one arrow-like visual content VC_2 may be formed as a whole by the animated guidance images I_A_3, I_A_4, and I_A_5 and the arrow image I_2_2.

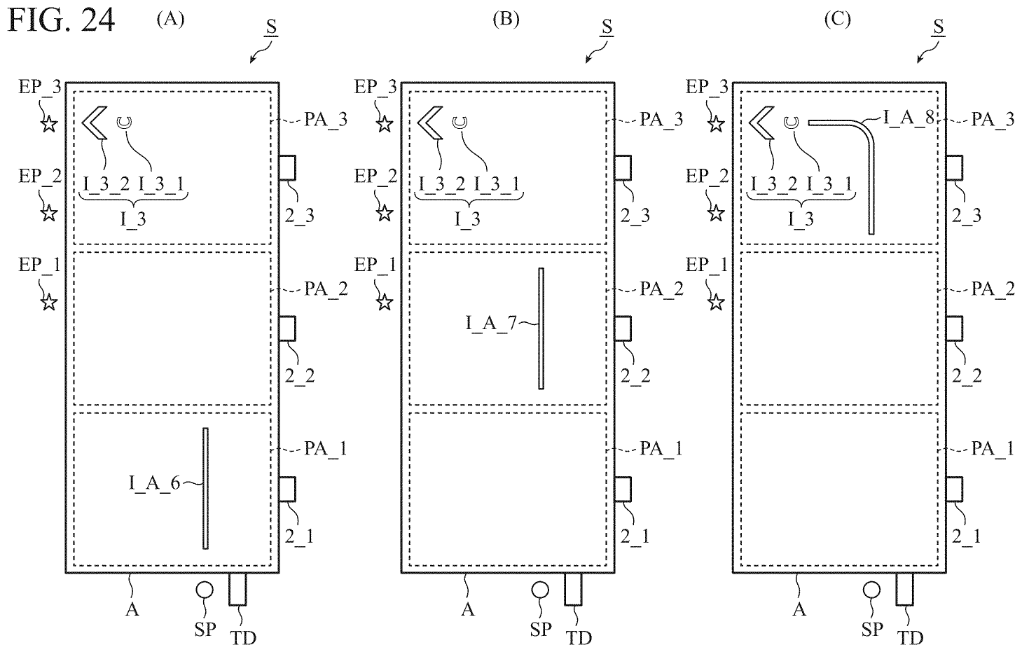

FIG. 24 illustrates an example of the guidance image group IG projected when the external information indicating that the third elevator is selected is acquired. That is, the state illustrated in FIG. 24 is a state corresponding to the guidance with the guidance route GR_3.

As illustrated in FIG. 24, a guidance image I_3 is projected at a position corresponding to the guidance target point EP_3 in the partial area PA_3. The guidance image I_3 includes a text image I_3_1 and an arrow image I_3_2. The text image I_3_1 includes a character “C”. The arrow image I_3_2 indicates the position of the third elevator.

Further, as illustrated in FIG. 24, animated guidance images I_A_6, I_A_7, and I_A_8 are projected by the projection devices 2_1, 2_2, and 2_3, respectively. The animated guidance images I_A_6, I_A_7, and I_A_8 are sequentially projected for the predetermined time t. In addition, the animated guidance images I_A_6, I_A_7, and I_A_8 are repeatedly projected. The visual content VC_3 is formed by the cooperation of the animated guidance images I_A_6, I_A_7, and I_A_8. The visual content VC_3 is visually recognized, for example, as if one linear image is moving along the guidance route GR_3. With such cooperation, effects similar to those described in the first embodiment can be obtained.

Here, the arrow image I_3_2 may be an animated arrow image linked with the animated guidance images I_A_6, I_A_7, and I_A_8. That is, one arrow-like visual content VC_3 may be formed as a whole by the animated guidance images I_A_6, I_A_7, and I_A_8 and the arrow image I_3_2.

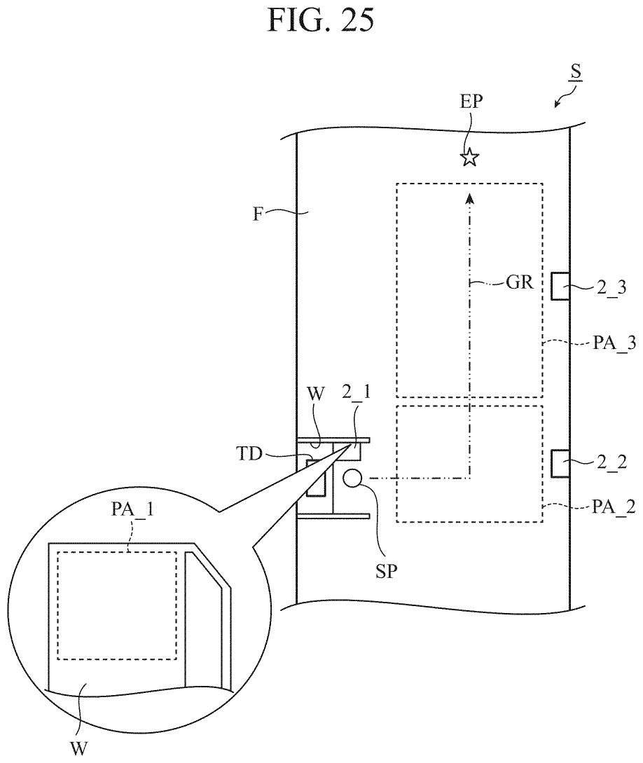

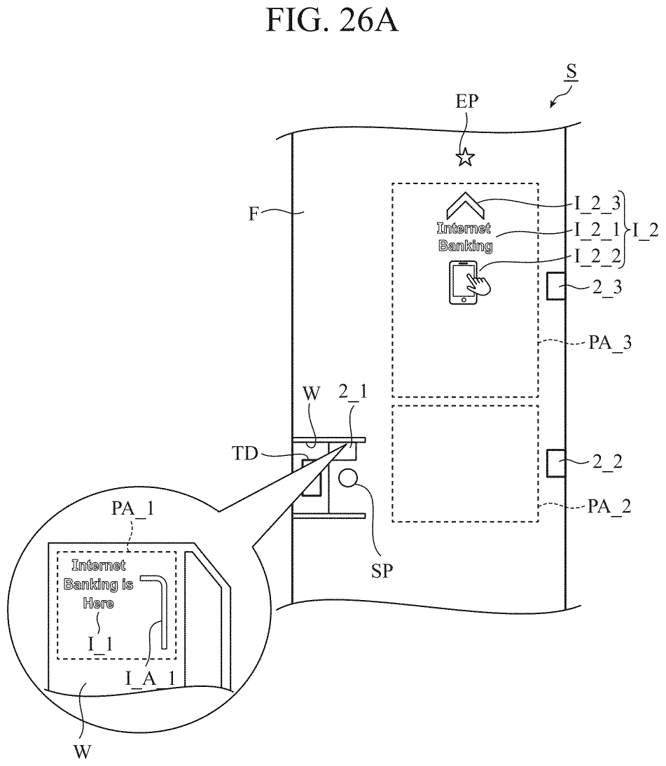

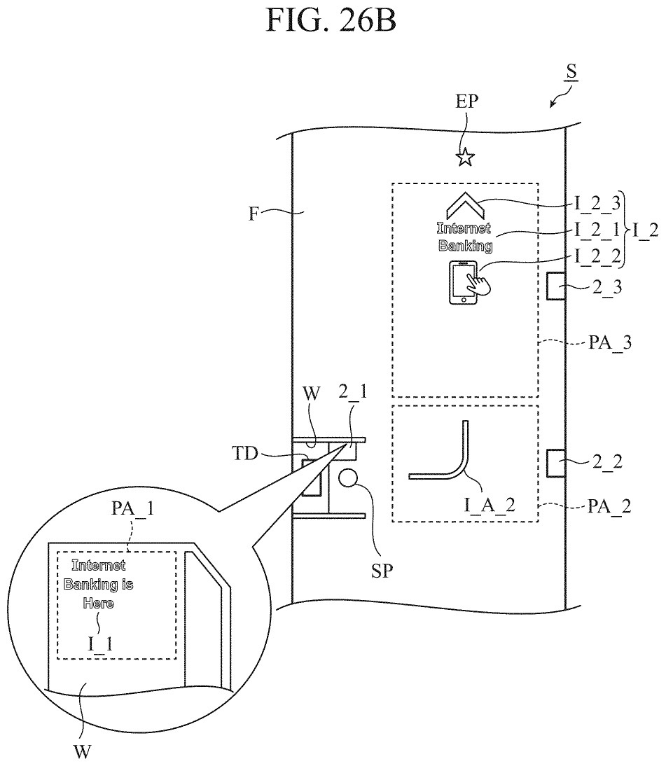

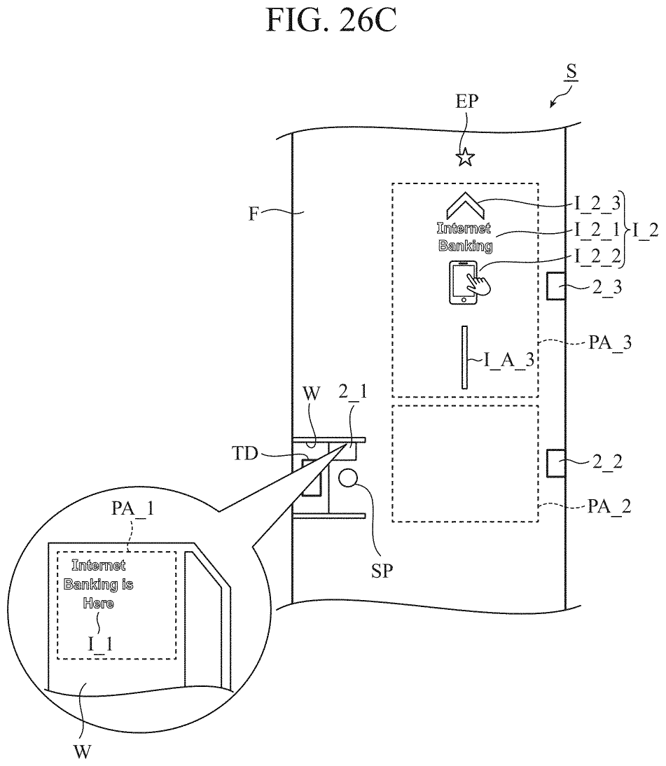

Next, yet another specific example of the visual content VC implemented by the guidance system 100a will be described with reference to FIGS. 25 and 26.

Now, a terminal device TD for reception is installed in a bank. In addition, there are a plurality of facilities in the bank. The facilities include, for example, an automatic teller machine (ATM), a video consultation service, and an Internet banking corner. The guidance target space S in the example illustrated in FIGS. 25 and 26 is a space in the bank.

The external device 4 in the example illustrated in FIGS. 25 and 26 includes the terminal device TD. The guidance target person (that is, the user of the bank) selects one facility that the guidance target person desires to use among the plurality of facilities, and inputs information indicating the selected one facility to the terminal device TD. The input information is external information. Hereinafter, an example in a case where the Internet banking corner is selected will be mainly described.

In this case, as illustrated in FIG. 25, one guidance route GR is set in the guidance target space S. The guidance route GR corresponds to the guidance start point SP and the guidance target point EP. The guidance start point SP corresponds to a position where the terminal device TD is installed. The guidance target point EP corresponds to the Internet banking corner.

In the example illustrated in FIGS. 25 and 26, the projection target area A includes three partial areas PA_1, PA_2, and PA_3. In the guidance target space S, three projection devices 2_1, 2_2, and 2_3 corresponding to the three partial areas PA_1, PA_2, and PA_3 on a one-to-one basis are installed.

One partial area PA_1 of the three partial areas PA_1, PA_2, and PA_3 is set on the wall surface portion W. More specifically, one partial area PA_1 is set on the wall surface portion W in a partition installed on the side of the terminal device TD. On the other hand, two partial areas PA_2 and PA_3 of the three partial areas PA_1, PA_2, and PA_3 are set on the floor surface portion F. The three partial areas PA_1, PA_2, and PA_3 are arranged along the guidance route GR.

As illustrated in FIG. 26, a guidance image I_1 is projected onto the partial area PA_1. The guidance image I_1 includes a text image. The text image includes a Japanese character string that means “Internet banking is here”.

In addition, as illustrated in FIG. 26, a guidance image I_2 is projected onto the partial area PA_3. The guidance image I_2 includes a text image I_2_1, an icon image I_2_2, and an arrow image I_2_3. The text image I_2_1 includes a Japanese character string that means “Internet banking”. The icon image I_2_2 includes a pictogram indicating a state where the smartphone is operated. The arrow image I_2_3 indicates the position of the Internet banking corner.

Further, as illustrated in FIG. 26, animated guidance images I_A_1, I_A_2, and I_A_3 are projected by the projection devices 2_1, 2_2, and 2_3, respectively. The animated guidance images I_A_1, I_A_2, and I_A_3 are sequentially projected for the predetermined time t. In addition, the animated guidance images I_A_1, I_A_2, and I_A_3 are repeatedly projected. The visual content VC is formed by the cooperation of the animated guidance images I_A_1, I_A_2, and I_A_3. The visual content VC is visually recognized, for example, as if one linear image is moving along the guidance route GR. With such cooperation, effects similar to those described in the first embodiment can be obtained.

Here, the arrow image I_2_3 may be an animated arrow image linked with the animated guidance images I_A_1, I_A_2, and I_A_3. That is, one arrow-like visual content VC may be formed as a whole by the animated guidance images I_A_1, I_A_2, and I_A_3 and the arrow image I_2_3.

As described above, the visual content VC based on the external information can be implemented by using the external information. Specifically, for example, it is possible to implement the visual content VC related to the guidance with the guidance route GR suitable for the guidance target person.

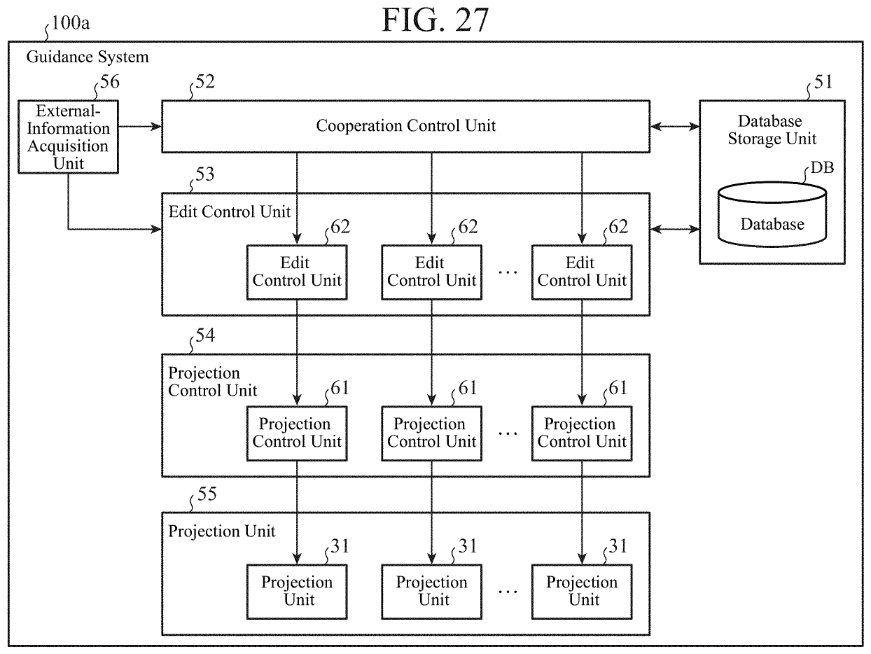

Note that the guidance system 100a can adopt various modifications similar to those described in the first embodiment. For example, as illustrated in FIG. 27, the edit control unit 53 may include a plurality of edit control units 62.

As described above, the guidance system 100a according to the second embodiment includes the external-information acquisition unit 56 that acquires information (external information) output by the external device 4, and the edit control unit 53 uses the information (external information) acquired by the external-information acquisition unit 56 to edit the guidance image group IG. As a result, the guidance image group IG based on the external information can be implemented. Furthermore, the visual content VC based on the external information can be implemented.

Note that, within the scope of the present invention, the present invention can freely combine each embodiments, modify any component in each embodiments, or omit any component in each embodiments.

### INDUSTRIAL APPLICABILITY

The guidance system of the present invention can be used for, for example, guiding a user of a facility in a space in the facility (for example, an airport, a bank, a station, or an office building).

### REFERENCE SINGS LIST

1: control device, 2: projection device, 3: projection device group, 4: external device, 11: storage unit, 12: communication unit, 13: control unit, 21: memory, 22: transmitter, 23: receiver, 24: processor, 25: memory, 26: processing circuit, 31: projection unit, 32: communication unit, 33: control unit, 41: projector, 42: transmitter, 43: receiver, 44: processor, 45: memory, 46: processing circuit, 51: database storage unit, 52: cooperation control unit, 53: edit control unit, 54: projection control unit, 55: projection unit, 56: external-information acquisition unit, 61: projection control unit, 62: edit control unit, 100, 100a: guidance system

1. A guidance system comprising a projection device group to project a guidance image group onto a projection target area in a guidance target space; and
processing circuitry,
the projection target area includes a plurality of partial areas including a plurality of guidance routes and arranged depending on a shape of the plurality of guidance routes,
the projection device group includes a plurality of projection devices corresponding to the plurality of partial areas,
the guidance image group includes two or more animated guidance images in each of the plurality of guidance routes, and
each of two or more of the plurality of projection devices sequentially projects, in each of the plurality of guidance routes, each of the two or more animated guidance images corresponding to each of the plurality of guidance routes so as to form a visual content for guidance that is continuous by cooperation of the two or more animated guidance images.

2. The guidance system according to claim 1
wherein the processing circuitry is configured to execute control to edit the guidance image group, wherein
the executed control includes control to generate the two or more animated guidance images by dividing an animated edit image.

3. The guidance system according to claim 2, wherein
the processing circuitry includes a plurality of edit circuits, and
each of the plurality of edit circuits is provided in each of the plurality of projection devices.

4. The guidance system according to claim 1, wherein
two or more partial areas corresponding to the two or more animated guidance images among the plurality of partial areas are arranged along a guidance route corresponding to the visual content, and
a number of the two or more partial areas is set to a number depending on a length of the guidance route.

5. The guidance system according to claim 2, wherein the processing circuitry is further configured to acquire information output by an external device, wherein
each edit circuit uses the acquired information to edit the guidance image group.

6. The guidance system according to claim 1, wherein the visual content is visually recognized as if a predetermined number of unit images with a predetermined shape are moving along a guidance route corresponding to the visual content.

7. The guidance system according to claim 6, wherein the unit image includes one linear image or a plurality of linear images.

8. The guidance system according to claim 1, wherein the visual content is formed for a predetermined time by repeatedly projecting the two or more animated guidance images.

9. A guidance method using a projection device group to project a guidance image group onto a projection target area in a guidance target space and being executed by a control device to control the projection device group, comprising:
including a plurality of partial areas in the projection target area including a plurality of guidance routes and arranged depending on a shape of the plurality of guidance routes;
including a plurality of projection devices corresponding to the plurality of partial areas in the projection device group;
including two or more animated guidance images in each of the plurality of guidance routes, in the guidance image group;
sequentially projecting, by each of two or more of the plurality of projection devices, each of the two or more animated guidance images corresponding to each of the plurality of guidance routes, in each of the plurality of guidance routes; and
forming a visual content for guidance that is continuous by cooperation of the two or more animated guidance images.
